(19) United States
(12) Patent Application Publication
(10) Pub. No.: US 2008/0088725 A1
(43) Pub. Date: Apr. 17, 2008

(54) Solid-state imaging device

(76) Inventor: Yoshiyuki Matsunaga, Kanagawa (JP)

Correspondence Address: MCDERMOTT WILL & EMERY LLP, 600 13TH STREET, NW, WASHINGTON, DC, 20005-3096, US

(21) Appl. No.: 11/819,577

(22) Filed: Jun. 28, 2007

(30) Foreign Application Priority Data
Oct. 12, 2006 (JP) 2006-278385

(51) Int. Cl. H04N 3/14

(52) U.S. Cl. 348/302; 348/E03.016

(57) ABSTRACT

An amplification-type solid-state imaging device adds a plurality of signals from pixels of the same color, R, G, or B, in order to output the signals. A gravity center in each group of added pixels is arranged without being partial in a pixel region.

### BACKGROUND OF THE INVENTION

1. Technical Field

The present invention relates to a solid-state imaging device with a pixel addition mode.

2. Related Art

Further improvement in image quality and functions is demanded in imaging devices such as digital still cameras, and solid-state imaging devices mounted on the imaging devices employ a technique to implement a high speed by a pixel addition or pixel mixture method. Explanation will be made for a solid-state imaging device according to a conventional technique disclosed in Japanese Patent Application Publication No. 2004-312140, the entire contents of which being herein incorporated in reference, with reference to drawings.

FIG. 25 is a configuration diagram of the solid-state imaging device disclosed in Japanese Patent Application Publication No. 2004-312140.

Reference numeral 1011 is a photoelectric conversion element and a color filter attached to a front surface thereof. It is assumed here that a color filter array is a Bayer array, for example. Although Gr and Gb are the same color in practice, a filter pixel held by an R filter on both horizontal sides is indicated as Gr, and a filter pixel held by a B filter on both horizontal sides is indicated as Gb, for convenience of explaining an operation. Reference numeral 1012 is a vertical transfer stage of twelve phases composed of V1 through V12; 1013 is a horizontal transfer stage of two phases composed of H1 and H2; 1014 is an output amplifier; 1015 is a vertical-horizontal transfer control portion composed of V13 through V48 with an independently wired gate, which is extended from the twelve-phase vertical transfer stage 1012 composed of V1 through V12; 1016 is a basic unit of a pixel addition area of Gr; 1017 is a basic unit of a pixel addition area of B; 1018 is a basic unit of a pixel addition area of Gb; and 1019 is a basic unit of a pixel addition area of R.

Signal electric charge from the photoelectric conversion element is read out to the vertical transfer stage 1012, and three pixels of the same color are added in the vertical transfer stage 1012 for each color. The vertical-horizontal transfer control portion 1015 drives all the gates of V13 through V48 in a normal six-phase mode in the same manner as the vertical transfer stage 1012, so that the signal electric charges of Gr and R for which the above-stated three pixels have been added are stored in the vertical-horizontal transfer control portion 1015. Next, V37 through V42 and V19 through V24 in the vertical-horizontal transfer portion 1015 are exclusively operated in the normal six-phase drive, so that signal electric charges of Gr and R in a line of V42 and a line of V24 are exclusively transferred into the horizontal transfer stage 1013. Next, the horizontal transfer stage 1013 is subjected to a two-stage transfer in a normal two-phase drive mode. Thereafter, V25 through V30 and V43 through V48 in the vertical-horizontal transfer control portion 1015 are exclusively operated in the normal six-phase drive, so that signal electric charges of Gr and R in a line of V30 and a line of V48 are exclusively transferred into the horizontal transfer stage 1013 and added to signal electric charges of the same color stored in the horizontal transfer stage 1013, and thereby addition of signal electric charges of a total of six pixels is realized each in Gr and R in the horizontal transfer stage 1013. Furthermore, after a two-stage transfer is performed in the horizontal transfer stage 1013 in the normal two-phase drive mode, V13 through V18 and V31 through V36 in the vertical-horizontal transfer control portion 1015 are exclusively operated in the normal six-phase drive, so that signal electric charges of Gr and R in a line of V18 and a line of V36 are exclusively transferred into the horizontal transfer stage 1013 and added to signal electric charges in the same color stored in the horizontal transfer stage 1013, and thereby addition of signal electric charges of a total of nine pixels is realized each in Gr and R in the horizontal transfer stage 1013. Thereafter, the horizontal transfer stage 1013 is operated in the normal two-phase drive, and signals of Gr and R for which nine pixels have been added are outputted from respective solid-state imaging elements via the output amplifier 1014.

A series of the above stated operations are repeated, so that signals of B and Gb for which nine pixels have been added from the solid-state imaging elements are outputted in a subsequent line.

As a conventional technique, Japanese Patent Application Publication No. 2001-36920, the entire contents of which being herein incorporated by reference, discloses a solid-state imaging device which performs four-pixel addition (partially two-pixel addition).

### SUMMARY OF THE INVENTION

Digital still cameras or compact digital still cameras currently available are used in many cases in a still picture photographing mode when pixel addition is not performed in the solid-state imaging devices mounted on the cameras, or when pixel addition is performed, in what is called a motion picture monitor mode in which a subject is portrayed in order to photograph a still picture, or in a motion picture photographing mode which is performed in a state of having a significantly reduced resolution in comparison with that of a still picture. In digital still cameras on which solid-state imaging devices are mounted, the number of pixels currently regarded as highest pixels is about 10 million pixels, and high-speed implementation and high pixelation or high resolution are demanded to be compatible on a higher level within that limited number of pixels.

However, there were cases where the solid-state imaging device of a nine-pixel addition system disclosed in the JP2004-312140 publication could not be used for imaging devices in which high-speed implementation and high pixelation are demanded to be compatible on a high level (e.g., single-lens digital still cameras), due to a large reduction in the number of added or mixed pixels.

Moreover, in the solid-state imaging device disclosed in the JP2001-36920 publication, the number of added G pixels, which are most important, is only two, and addition is simply made in a unidirectional oblique state, thereby having defects of low density and a resolution difference between a right oblique state and a left oblique state to cause fault resolutions (moires).

Taking the above stated problems into consideration, the present invention provides a solid-state imaging device and a driving method thereof, in which high-speed implementation and high pixelation (higher resolution) are made compatible, and pixel addition is performed.

Taking the above stated problems into consideration, a first solid-state imaging device according to the present invention is a solid-state imaging device having a plurality of pixels each including a light receiving portion arranged on a semiconductor substrate in a matrix form. Pixels among the plurality of pixels to extract signals of green, red, and blue are assumed green pixels, red pixels, and blue pixels, respectively, so as to arrange a pair of green pixels, red pixels, and blue pixels in a Bayer array. The first solid-state imaging device has a drive mode to mutually add signals obtained from pixels of the same color, and is characterized by using horizontal two pixels and vertical four pixels of the green pixels as a basic unit of a green pixel addition area, and horizontal three pixels and vertical three pixels of the blue pixels and the red pixels as a basic unit of a blue pixel addition area and a red pixel addition area, respectively, in order to mutually add signals from the green pixels in the green pixel addition area, signals from the blue pixels in the blue pixel addition area, and signals from the red pixels in the red pixel addition area.

In the first solid-state imaging device according to the present invention, the green pixel addition area is provided with a first green pixel addition area and a second pixel addition area, and the first green pixel addition area and the second green pixel addition area are more preferably arranged having a deviation of two pixels in the horizontal direction.

In the first solid-state imaging device according to the present invention, the first green pixel addition area and the second green pixel addition area are more preferably arranged to overlap the blue pixel addition area and the red pixel addition area.

In the first solid-state imaging device according to the present invention, the first green pixel addition area is more preferably arranged to overlap the blue pixel addition area and the red pixel addition area, the second green pixel addition area is more preferably arranged to overlap the red pixel addition area.

In the first solid-state imaging device according to the present invention, the first green pixel addition area and the second green pixel addition area are more preferably arranged in the same position in the horizontal direction.

In the first solid-state imaging device according to the present invention, the first green pixel addition area is more preferably arranged to overlap the blue pixel addition area and the red pixel addition area, and the second green pixel addition area is more preferably arranged to overlap the blue pixel addition area.

Furthermore, a second solid-state imaging device according to the present invention is a solid-state imaging device having a plurality of pixels each including a light receiving portion arranged on a semiconductor substrate in a matrix form, wherein: pixels among the plurality of pixels to extract signals of green, red, and blue are assumed green pixels, red pixels, and blue pixels, respectively; and a pair of green pixels, red pixels, and blue pixels are arranged in a Bayer array; comprising a drive mode to mutually add signals obtained from pixels of the same color, and characterized by using horizontal two pixels and vertical four pixels of the green pixels as a basic unit of a green pixel addition area, and horizontal three pixels and vertical three pixels of the blue pixels and the red pixels as a basic unit of a blue pixel addition area and a red pixel addition area, respectively, in order to mutually add signals from the green pixels in the green pixel addition area, signals from one or some of the blue pixels in the blue pixel addition area, and signals from one or some of the red pixels in the red pixel addition area.

In the second solid-state imaging device according to the present invention, the green pixel addition area is more preferably provided with a first green pixel addition area and a second pixel addition area, and the first green pixel addition area and the second green pixel addition area are more preferably arranged having a deviation of two pixels in the horizontal direction.

In the second solid-state imaging device according to the present invention, the first green pixel addition area and the second green pixel addition area are more preferably arranged to overlap the blue pixel addition area and the red pixel addition area.

In the second solid-state imaging device according to the present invention, the green pixel addition area is more preferably provided with a first green pixel addition area and a second green pixel addition area, and the first green pixel addition area and the second green pixel addition area are more preferably arranged in the same position in the horizontal direction.

In addition, the first and second solid-state imaging devices according to the present invention comprise the light receiving portions, a transfer means, an amplification means, and a vertical signal line to transmit a signal from the amplification means, wherein the vertical signal line is more preferably provided with four signal storage means in a rear stage thereof.

Moreover, the first and second solid-state imaging devices according to the present invention comprise the light receiving portions, a transfer means, an amplification means, and two vertical signal lines to transmit a signal from the amplification means, wherein the vertical signal lines are more preferably made to correspond to an odd-number row and a even-number row, having two signal storage means to be provided for to each of the vertical signal lines.

Furthermore, in the first and second solid-state imaging devices according to the present invention, each of the vertical signal lines is more preferably provided with two selection means in a rear stage of the signal storage means.

### BRIEF DESCRIPTION OF THE DRAWINGS

FIG. 1 is an image diagram showing a pixel addition pattern of a solid-state imaging device and a driving method thereof according to a first embodiment of the present invention;

FIG. 2 is an image diagram showing a pixel addition pattern of a solid-state imaging device and a driving method thereof according to a modified example 1 of the first embodiment;

FIG. 3 is an image diagram showing a pixel addition pattern of a solid-state imaging device and a driving method thereof according to a modified example 2 of the first embodiment;

FIG. 4 is an image diagram showing a pixel addition pattern of a solid-state imaging device and a driving method thereof according to a second embodiment of the present invention;

FIG. 5 is a circuit diagram showing a configuration of the solid-state imaging device according to the first embodiment;

FIG. 6 is a circuit diagram showing a configuration of the solid-state imaging device according to the second embodiment;

FIG. 7 is a circuit diagram showing a second configuration of the solid-state imaging device according to the first embodiment;

FIG. 8 is a circuit diagram showing a second configuration of the solid-state imaging device according to the second embodiment;

FIG. 9 is an image diagram showing a pixel addition pattern in a solid-state imaging device according to a comparative example;

FIG. 10 is a circuit diagram showing a third configuration of the solid-state imaging device according to the first embodiment;

FIG. 11 is a circuit diagram showing a third configuration of the solid-state imaging device according to the second embodiment;

FIG. 12 is a circuit diagram showing a first configuration of a solid-state imaging device according to a third embodiment of the present invention;

FIG. 13 is a circuit diagram showing a first configuration of a solid-state imaging device according to a fourth embodiment of the present invention;

FIG. 14 is a circuit diagram showing a first configuration of a solid-state imaging device according to a fifth embodiment of the present invention;

FIG. 15 is a circuit diagram showing a fourth configuration of the solid-state imaging device according to the first embodiment;

FIG. 16 is a circuit diagram showing a fourth configuration of the solid-state imaging device according to the second embodiment;

FIG. 17 is a circuit diagram showing a second configuration of the solid-state imaging device according to the third embodiment;

FIG. 18 is a circuit diagram showing a second configuration of the solid-state imaging device according to the fourth embodiment;

FIG. 19 is a circuit diagram showing a second configuration of the solid-state imaging device according to the fifth embodiment;

FIG. 20 is an image diagram showing a pixel addition pattern of the solid-state imaging device and a driving method thereof according to the third embodiment;

FIG. 21 is an image diagram showing a pixel addition pattern of the solid-state imaging device and a driving method thereof according to the fourth embodiment of the present invention;

FIG. 22 is an image diagram showing a pixel addition pattern of the solid-state imaging device and a driving method thereof according to the fifth embodiment of the present invention;

FIG. 23 is a circuit configuration diagram of a photoelectric conversion cell in an MOS-type image sensor according to the first embodiment;

FIG. 24 is a device configuration diagram showing an imaging device according to a sixth embodiment of the present invention; and

FIG. 25 is a configuration diagram of a conventional solid-state imaging device.

### DESCRIPTION OF THE PREFERRED EMBODIMENTS

### First Embodiment

Explained below will be a solid-state imaging device and a driving method thereof according to a first embodiment of the present invention with reference to drawings.

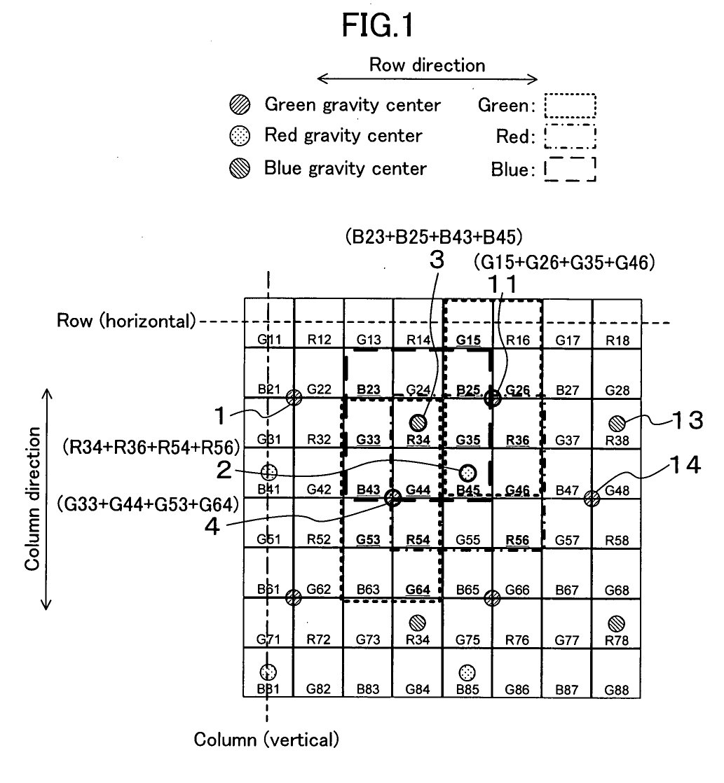

FIG. 1 is an image diagram showing a pixel addition pattern of the solid-state imaging device and the driving method thereof according to the first embodiment of the present invention.

As shown in FIG. 1, a color filter array is a Bayer array, for example. A filter pixel held by an R filter on both horizontal sides is made to be Gr, and a filter pixel held by a B filter on both horizontal sides is made to be Gb for convenience of explaining an operation, but Gr and Gb are the same color in practice.

As shown in FIG. 1, green (hereinafter referred to as G) G15, G26, G35, and G46 are formed into a first G group, G33, G44, G53, and G64 are formed into a second G group, red (hereinafter referred to as R) R34, R54, R36, and R56 are formed into an R group, blue (hereinafter referred to as B) B23, B25, B43 and B45 are formed into a B group, in order to perform pixel addition (four-pixel addition) in the color filter array.

Due to the pixel addition, a gravity center of the first G group is made to be a G1 gravity center 11, a gravity center of the R group is made to be an R gravity center 2, a gravity center of the B group is made to be a B gravity center 3, and a gravity center of the second G group is made to be a G2 gravity center 4.

Accordingly, if pixel addition is performed in the solid-state imaging device according to the first embodiment of the present invention as shown in FIG. 1, each of the gravity centers including the G1 gravity center 11, the R gravity center 2, the B gravity center 3, and the G2 gravity center 4 can be arranged without being partial relative to each of a group of adjacent gravity centers including a G1 gravity center (not shown), an R gravity center (not shown), a B gravity center 13, and a G2 gravity center 14.

Moreover, if pixel addition is performed in the solid-state imaging device according to the first embodiment of the present invention as shown in FIG. 1, an arrangement of a set of the four gravity centers including the G1 gravity center 11, the R gravity center 2, the B gravity center 3, and the G2 gravity center 4 can be made similar to a Bayer array RG/GB exhibited before performing pixel addition.

Furthermore, if pixel addition is performed in the solid-state imaging device according to the first embodiment of the present invention as shown in FIG. 1, a gravity center of green, which determines a visual resolution, can be arranged in a checkered pattern without being partial.

Explained next will be a device configuration of the solid-state imaging device according to the first embodiment of the present invention. In the solid-state imaging device according to the first embodiment of the present invention, any of first to fourth configurations described below can be employed.

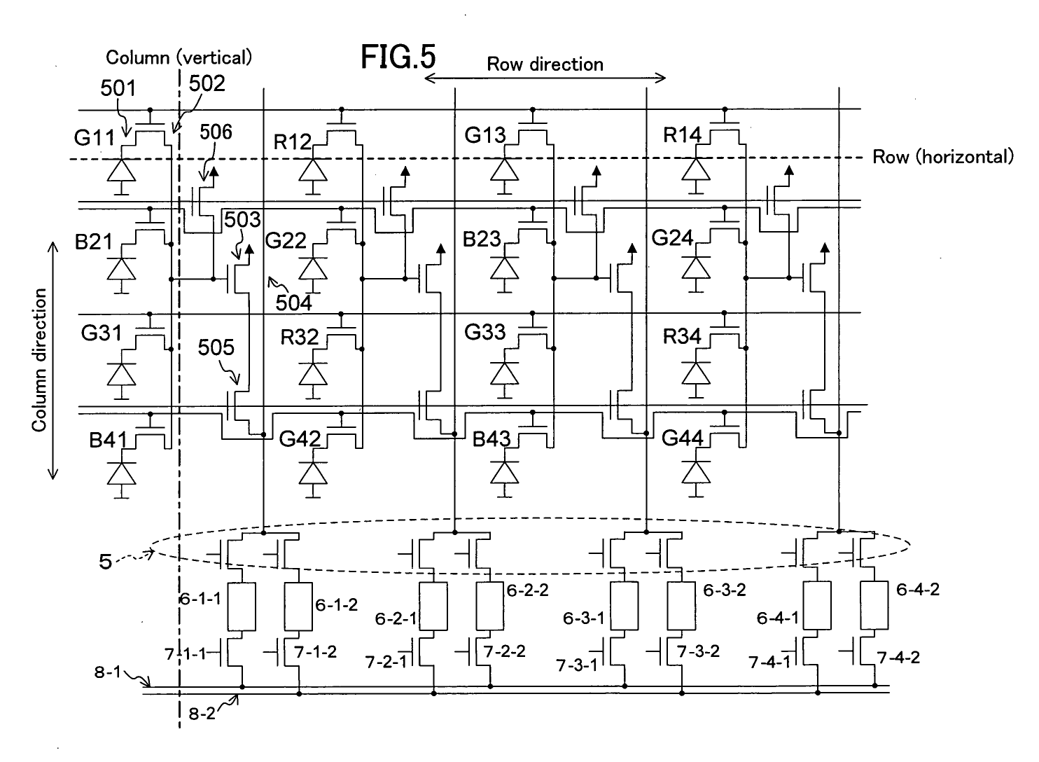

First, FIG. 5 is used to explain a first configuration of the solid-state imaging device according to the first embodiment of the present invention, in which pixel addition as shown in FIG. 1 is performed.

As shown in FIG. 5, the solid-state imaging device is an amplification-type solid-state imaging device, and light which was made incident to a photo diode 501 provided internally in a silicon substrate is photoelectrically converted and stored as electric charge. Electric charge is also transferred to a gate electrode of an amplifier transistor 503 after having been stored for a predetermined period of time by opening a transfer gate 502, and an amplified signal is outputted as a signal voltage to a vertical signal line 504 via a selection transistor 505. A signal voltage appeared on the vertical signal line 504 is temporarily stored in signal storage capacities 6-1-1, 6-1-2 . . . 6-n-1, and 6-n-2 by passing through a group of signal distribution transistors 5. Thereafter, horizontal switches 7-1-1, 7-1-2 . . . 7-n-1, and 7-n-2 are successively turned on, so that a signal is read from horizontal signal lines 8-1 and 8-2 successively. Electric charge transferred to the gate electrode of the amplifier transistor 503 is ejected by turning on a reset transistor 506.

Moreover, due to simultaneous readout of two lines of G11, R12, . . . and G31, R32 . . . , added signals of G11 and G31, R12 and R32, G13 and G33, and R14 and R34 are stored in the signal storage capacities 6-1-1, 6-2-1, 6-3-1, and 6-4-1, respectively, by turning on a switch on a left side of two switches provided in one of vertical signal lines in the group of the signal distribution transistors 5.

Next, the horizontal switches 7-2-1 and 7-4-1 are simultaneously turned on to output a signal of addition of R12, R32, R14, and R34 from the second horizontal signal line 8-2.

Next, two lines of B21, G22, . . . and B41, G42 . . . are simultaneously read out, and a switch on a right side of two switches provided in one of the vertical signal lines in the group of the signal distribution transistors 5 is turned on. Therefore, added signals of B21 and B41, G22 and G42, B23 and B43, and G24 and G44 are stored in the signal storage capacities 6-1-2, 6-2-2, 6-3-2, and 6-4-2, respectively.

Next, the horizontal switches 7-1-2 and 7-3-2 are simultaneously turned on to output a signal of addition of B21, B41, B23, and B43 from the second horizontal signal line 8-2.

Next, the horizontal switches 7-1-1 and 7-2-2 are simultaneously turned on to output a signal of addition of G11, G31, G22, and G44 from the first horizontal signal line 8-1. Furthermore, the horizontal switches 7-3-1 and 7-4-2 are simultaneously turned on to output a signal of addition of G13, G33, G24, and G44 from the first horizontal signal line 8-1.

In the solid-state imaging device according to the first embodiment of the present invention, a signal of G11+G31 stored in the signal storage capacity 6-1-1 and a signal of G13+G33 stored in the signal storage capacity 6-3-1 are not read out for once in the first-time simultaneous readout of the two lines of G11, R12, and G31, R32, but the subsequent two lines of B21, G22, . . . and B41, G42 . . . are read out simultaneously.

Due to this device and driving, the solid-state imaging device according to the first embodiment of the present invention is capable of performing readout by waiting for the subsequent G signals of G22+G42 and G24+G44 to be stored in the horizontal storage capacities, so as to allow readout by adding G11+G31 and G22+G42.

Addition of G13+G33 and G24+G44 is driven in the same manner as the above stated addition of G11+G31 and G22+G42.

In driving the above stated addition of G11+G31 and G22+G42, the horizontal switches 7-2-1 and 7-4-1 (R signals) are turned on in the first readout, while turning on the horizontal switches 7-1-2 and 7-3-2 (B signals), the horizontal switches 7-1-1 and 7-2-2 (G1 signals), and the horizontal switches 7-3-1 and 7-4-2 (G2 signals) in the second readout, and these processes are repeated alternately, in which the number of signals is occasionally different between the first readout and the second readout. In this case (in the case of having a different amount of signals between the first readout and the second readout), the horizontal switches 7-2-1 and 7-4-1 (R signals), and the horizontal switches 7-1-1 and 7-2-2 (G1 signals) are turned on in the first readout, while turning on the horizontal switches 7-1-2 and 7-3-2 (B signals), and the horizontal switches 7-3-1 and 7-4-2 (G2 signals) in the second readout, and if these processes are driven to be repeated alternately, a readout arrangement as shown in FIG. 1 is realized due to a vertical deviation of two pixels in readout of green (G) pixels in every two lines.

That is, if the number of signals is different in the first readout and the second readout, this problem can be solved by switching readout between the horizontal switches 7-2-1 and 7-4-1 (R signals) of the first readout and the horizontal switches 7-1-2 and 7-3-2 (B signals) of the second readout.

Moreover, two pixels are simply added in the R and B pixels in the longitudinal direction, which allows for readout by single addition in the longitudinal direction, so that signals stored in the horizontal storage capacities can be added in the horizontal direction and read out immediately by turning on the horizontal switches.

However, four pixels are added in the G pixels in the longitudinal direction, and thereby signals obtained by single addition in the longitudinal direction cannot be read out immediately after having been stored in the storage capacities by turning on the horizontal switches. That is, it is required to wait for subsequent signals to be stored in the signal storage capacities by operating subsequent vertical addition once again. In other words, in the solid-state imaging device according to the first embodiment of the present invention, a gravity center of added four G pixels can be read out in a staggered (or checkered) pattern due to the method of waiting for the G signals being deviated in every adjacent two lines.

To be more specific, when the horizontal switches 7-2-1 and 7-4-1 are exclusively turned on in the first readout for readout of a signal of B of addition of four pixels, the horizontal switches 7-3-1 and 7-4-2 are simultaneously turned on for readout of added signals of G. Therefore, four-pixel addition is realized. Then, if the horizontal switches 7-1-1 and 7-2-2 are simultaneously turned on in the second readout, four pixels of G11+G31+G22+G42 are added, in which the horizontal switches 7-3-1 and 7-4-2 are not turned on.

Furthermore, when subsequent readout is performed, the horizontal switches 7-3-1 and 7-4-2 are turned on without turning on the horizontal switches 7-1-1 and 7-2-2. The readout as stated above allows a signal of addition of four pixels to be read out in a staggered (or checkered) pattern.

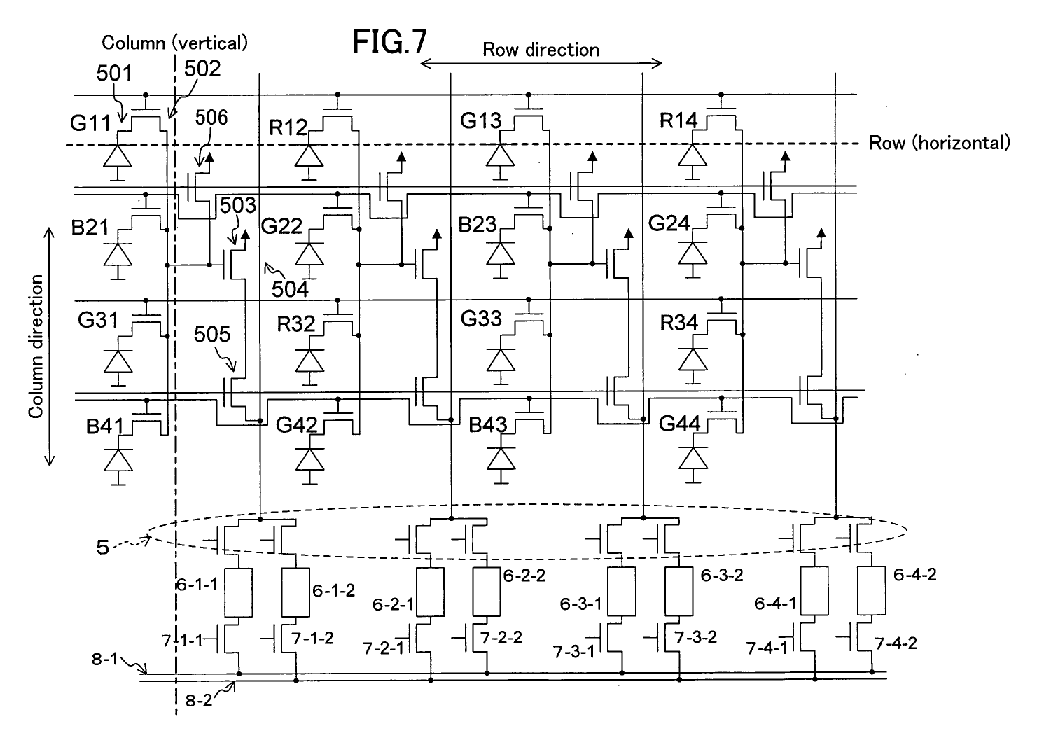

Next, FIG. 7 is used to explain a second configuration of the solid-state imaging device according to the first embodiment of the present invention, in which pixel addition as shown in FIG. 1 is performed.

As shown in FIG. 7, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 504 via the selection transistor 505. A signal voltage appeared on the vertical signal line 504 is temporarily stored in the signal storage capacities 6-1-1, 6-1-2 . . . 6-n-1, and 6-n-2 by passing through the group of the signal distribution transistors 5. Thereafter, the horizontal switches 7-1-1 and 7-1-2 are successively turned on, so that signals are read out from the horizontal signal lines 8-1 and 8-2 successively. Electric charge transferred to the gate electrode of the amplifier transistor 503 is ejected by turning on the reset transistor 506. That is, the difference from the first configuration as shown in FIG. 5 is that a pixel to read is switched in each line.

In the case of the second configuration, there is an advantage that a column which exclusively outputs G can be separated from columns which output R and B in the pixel configuration and pixel addition as shown in FIG. 1.

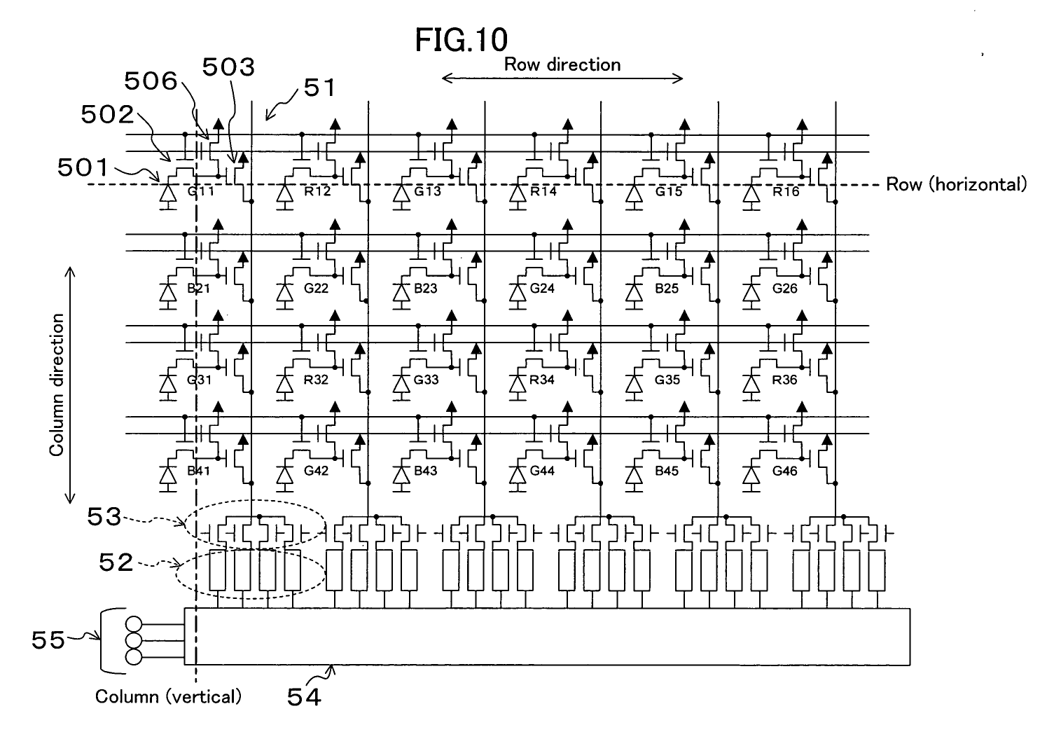

Next, FIG. 10 is used to explain a third embodiment of the solid-state imaging device according to the first embodiment of the present invention, in which pixel addition as shown in FIG. 1 is performed.

As shown in FIG. 10, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage from a vertical signal line 51.

Although FIG. 10 does not show a selection transistor, a selection transistor may be provided in the third embodiment.

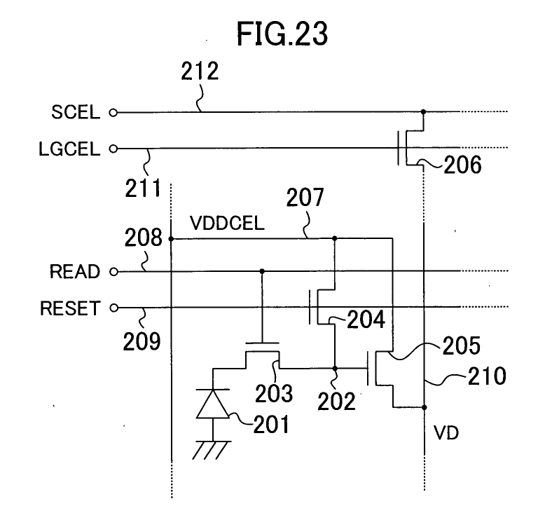

Explanation will be made using FIG. 23 for the solid-state imaging device according to this embodiment in the case of providing no selection transistor. FIG. 23 is a circuit configuration diagram of a photoelectric conversion cell in an MOS-type image sensor according to the first embodiment of the present invention, wherein: 201 is a PD portion to perform photoelectric conversion; 202 is an FD portion to store photoelectrically converted electric charge; 203 is a transfer gate to transfer electric charge to the FD portion 202; 204 is a reset gate to sweep electric charge of the FD portion 202; 205 is a pixel amplifier to detect electric charge of the FD portion 202; 206 is a load transistor to form a source follower amplifier in cooperation with the pixel amplifier 205; 207 is a common power line to apply a common power voltage signal VDDCEL to the photoelectric conversion cell; 208 is a read pulse line to apply a read signal READ to the transfer gate 203; 209 is a reset pulse line to which a rest signal RESET for sweeping electric charge of the FD portion 202 is applied; 210 is an output signal line to transmit a pixel signal VD detected in the pixel amplifier 205; 211 is a load gate line to apply a load gate signal LGCEL to a gate of the load transistor 206; and 212 is a source common power line to commonly apply a source power voltage signal SCEL to the load transistor 206.

As shown in FIG. 10, the vertical signal line 51 is provided to correspond to each column one by one, and a group of four signal storage capacities 52 is provided to correspond to this single output line.

It is a group of signal distribution switches 53 to distribute an output signal of the single vertical signal line 51 into the group of the four signal storage capacities 52. Addition of four pixels in the column direction and addition in the row direction are also performed by a horizontal multiplexer 54 so as to be distributed to a group of horizontal output lines 55. As it will be understood from this configuration, it is possible to store a signal of four pixels in the vertical direction while signals can be freely added in the horizontal direction by the horizontal multiplexer. Accordingly, pixel addition in this embodiment is made possible.

As explained above, the third configuration has the horizontal storage capacities provided twice as many as those of the first and second configurations, which results in a simple device configuration because signals successively read out in each column can be stored in this storage capacities successively, so that there is an advantage of allowing for pixel addition as shown in FIG. 1 even in this simple configuration.

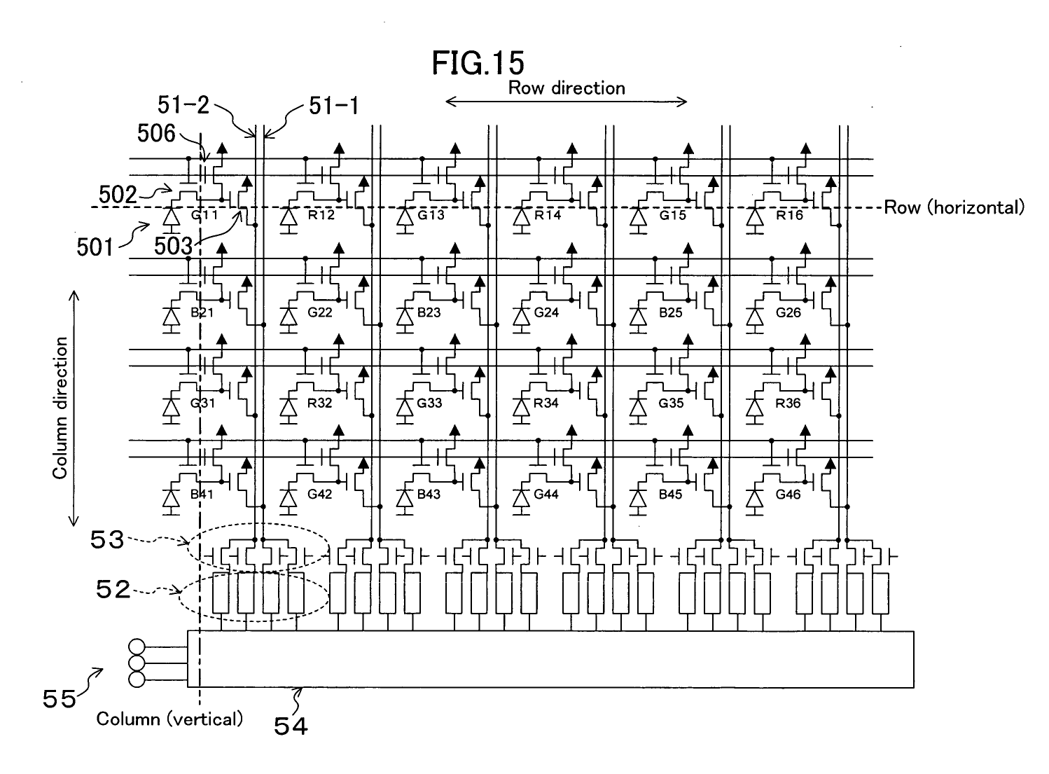

Next, FIG. 15 is used to explain a fourth configuration of the solid-state imaging device according to the first embodiment of the present invention, in which pixel addition as shown in FIG. 1 is performed.

As shown in FIG. 15, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to a vertical signal line 51-1 or 51-2. Two vertical signal lines, 51-1 and 51-2, are provided so as to correspond to an odd-number row and an even-number row. Two horizontal storage capacities and two horizontal switches are further provided for each of the vertical signal lines 51-1 and 51-2. It is the same as the third configuration that a total of four horizontal storage capacities and a total of four horizontal switches are provided with respect to a single column.

Addition of four pixels in the column direction and addition in the row direction are also performed by the horizontal multiplexer 54, so as to be distributed to the group of horizontal output lines 55.

As explained above, the fourth configuration has an advantage of allowing for improvement of a readout speed over the remaining configurations, because signals can be read out through the two vertical signal lines by selecting and operating two adjacent columns simultaneously.

As explained above by using the drawings of FIG. 1, FIG. 5, FIG. 7, FIG. 10, and FIG. 15, the solid-state imaging device according to the first embodiment of the present invention has the following superior characteristics.

First, the solid-state imaging device according to the first embodiment of the present invention is an MOS-type solid-state imaging device, and not operated in the same manner as a CCD (charge coupled device)-type solid-state imaging device, which reads out a signal by an electric charge transfer, and thus if these devices are compared assuming that no pixel addition is performed, an MOS-type solid-state imaging device is capable of reading out an electric charge signal faster than a CCD-type solid-state imaging device in general.

In a CCD-type solid-state imaging device disclosed in a conventional technique (Japanese Patent Application Publication No. 2004-312140), it is necessary to add many pixels for improvement of a readout speed, or more specifically, nine pixels are added for high-speed implementation.

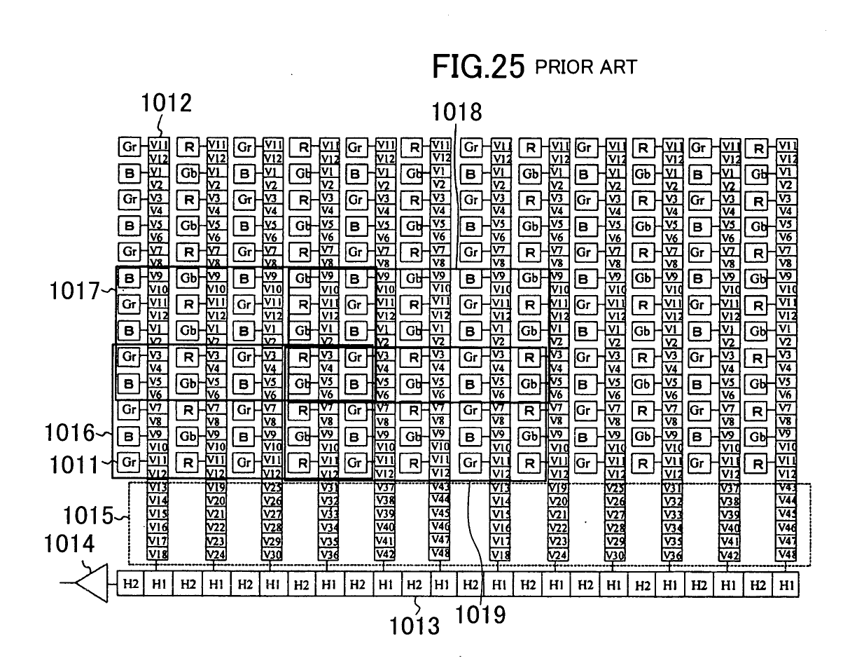

Meanwhile, in the solid-state imaging device according to the first embodiment of the present invention, high-speed implementation is realized by pixel addition in the same manner as the conventional technique (Japanese Patent Application Publication No. 2004-312140) as shown in FIG. 25, in which signal electric charge can be read faster than the CCD-type solid-state imaging device disclosed in the conventional technique (Japanese Patent Application Publication No. 2004-312140) even in pixel addition of four pixels, which is smaller than nine-pixel addition, due to the MOS-type configuration.

Moreover, in the solid-state imaging device according to the first embodiment of the present invention, it is possible to obtain a higher resolution than that of the solid-state imaging device disclosed in the conventional technique (Japanese Patent Application Publication No. 2004-312140), due to pixel addition of four pixels as shown in FIG. 1, which is smaller than nine-pixel addition.

Accordingly, the solid-state imaging device according to the first embodiment of the present invention is capable of obtaining higher resolution characteristics and higher readout speed characteristics at the same time than those of the conventional technique (Japanese Patent Application Publication No. 2004-312140). Furthermore, the solid-state imaging device according to the first embodiment of the present invention is capable of obtaining superior image characteristics with less moires (fault resolutions) than those of the solid-state imaging device disclosed in the conventional technique (Japanese Patent Application Publication No. 2001-36920), so that it is possible to prevent significant decrease of a vertical resolution with respect to a horizontal resolution caused by imbalance in pixel sampling density between the horizontal direction and the vertical direction, and prevent substantial sensitivity decrease because a signal of a pixel in a column which is not read out is not discarded.

In the solid-state imaging device according to the first embodiment of the present invention, an image obtained without performing pixel addition (hereinafter referred to as a first image) and an image obtained by performing pixel addition (hereinafter referred to as a second image) in the same solid-state imaging device can be both outputted as a still picture. This method is particularly effective for a single-lens digital still camera, which does not photograph a motion picture in general.

Furthermore, the solid-state imaging device according to the first embodiment of the present invention is capable of outputting both the first image and the second image as a motion picture. The solid-state imaging device according to the first embodiment of the present invention is also capable of outputting the first image as a still picture and the second image as a motion picture, in the same manner as the conventional technique. The solid-state imaging device according to the first embodiment of the present invention is further capable of outputting a motion picture in the first image and a still picture in the second image.

Although the solid-state imaging device according to the first embodiment of the present invention was exhibited by using the MOS-type solid-state imaging device as an example, it can be also realized by a solid-state imaging device which is not operated in the same manner as a CCD-type solid-state imaging device for reading out a signal by an electric charge transfer, examples including sensors of any types such as BASIS, CMOS sensor, SIT sensor, CMD (charge modulation device), and AMI (amplified MOS imager).

Although the solid-state imaging device according to the first embodiment of the present invention was explained in the case of four-pixel addition using FIG. 1, it can be applied to the case of adding pixels larger than four pixels (e.g., nine-pixel addition) in a solid-state imaging device with an extremely large number of pixels (e.g., 10 million pixels or larger) by arranging the position of gravity centers of respective colors in a relationship similar to that of FIG. 1.

### MODIFIED EXAMPLE 1 OF FIRST EMBODIMENT

A solid-state imaging device and a driving method thereof according to a modified example 1 of the first embodiment of the present invention will be explained below by referring to a diagram. Any one of the first to fourth configurations of the solid-state imaging device according to the first embodiment as shown in FIG. 5, FIG. 7, FIG. 10, and FIG. 15 is used for a device configuration of the solid-state imaging device according to this modified example 1.

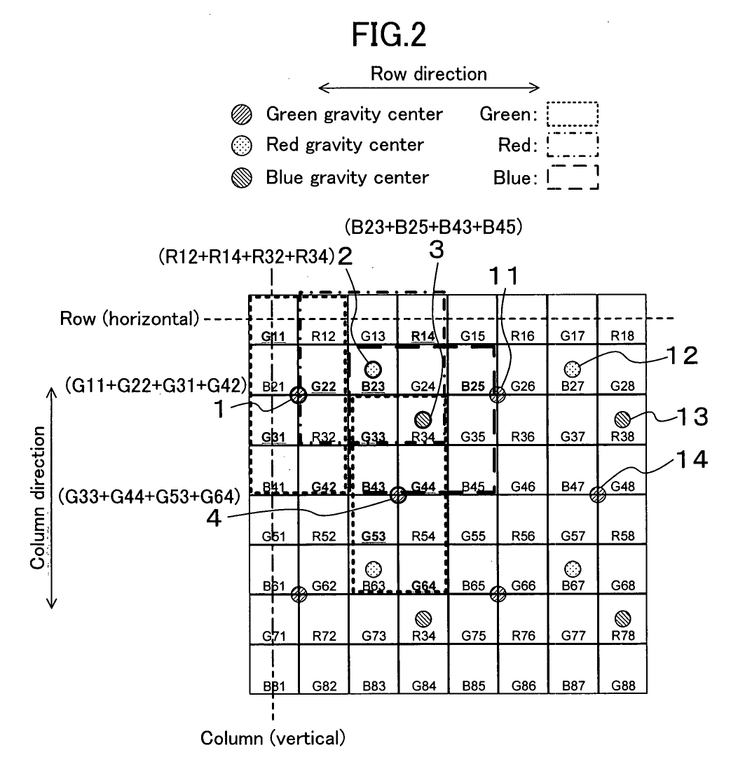

FIG. 2 is an image diagram showing a pixel addition pattern of the solid-state imaging device and the driving method thereof according to the modified example 1 of the first embodiment of the present invention.

As shown in FIG. 2, a color filter array is a Bayer array, for example, in which a filter pixel held by an R filter on both horizontal sides is made to be Gr, and a filter pixel held by a B filter on both horizontal sides is made to be Gb for convenience of explaining an operation, but Gr and Gb are the same color in practice.

As shown in FIG. 2, G11, G22, G31, and G42 are formed into a first G group; G33, G44, G53, and G64 are formed into a second G group; R12, R14, R32, and R34 are formed into an R group; and B23, B25, B43, and B45 are formed into a B group, so that output signals are added in each of the groups. In this case, a gravity center of the first G group is made to be a G1 gravity center 1. A gravity center of the R group is made to be an R gravity center 2. A gravity center of the B group is made to be a B gravity center 3. A gravity center of the second G group is made to be a G2 gravity center 4. Each of the gravity centers can be arranged without being partial relative to each of a group of adjacent gravity centers 11, 12, 13, and 14, and it is further possible to arrange green (G), which significantly influences resolution, in a checkered pattern without being partial.

### MODIFIED EXAMPLE 2 OF FIRST EMBODIMENT

A solid-state imaging device and a driving method thereof according to a modified example 2 of the first embodiment of the present invention will be explained below by referring to a diagram. Any one of the first to fourth configurations of the solid-state imaging device according to the first embodiment of the present invention as shown in FIG. 5, FIG. 7, FIG. 10, and FIG. 15 is used for a device configuration of the solid-state imaging device according to this modified example 2 of the first embodiment of the present invention.

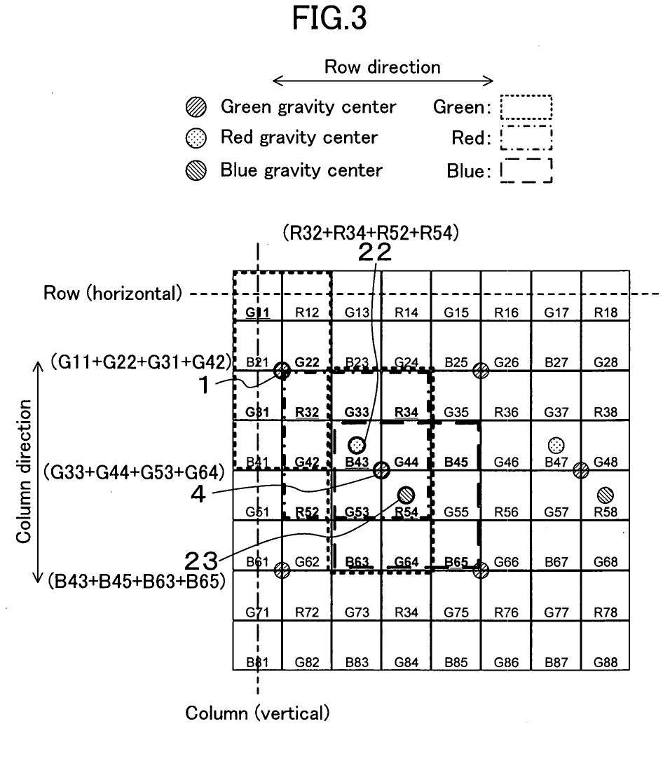

FIG. 3 is an image diagram showing a pixel addition pattern of the solid-state imaging device and the driving method thereof according to the modified example 2 of the first embodiment of the present invention.

As shown in FIG. 3, a color filter array is a Bayer array, for example, in which a filter pixel held by an R filter on both horizontal sides is made to be Gr, and a filter pixel held by a B filter on both horizontal sides is made to be Gb for convenience of explaining an operation, but Gr and Gb are the same color in practice.

As shown in FIG. 3, G11, G22, G31, and G42 are formed into a first G group; G33, G44, G53, and G64 are formed into a second G group; R32, R34, R52, and R54 are formed into an R group; and B43, B45, B63, and B65 are formed into a B group, so that output signals are added in each of the groups.

In this case, the G1 gravity center 1 and the G2 gravity center 4 are the same as those of the modified example 1 of the first embodiment of the present invention as shown in FIG. 2, and a downward deviation of two pixels was performed to obtain an R gravity center 22 and a B gravity center 23, so that green (G), which significantly influences resolution, can be arranged in a checkered pattern.

### Second Embodiment

Explained below will be a solid-state imaging device and a driving method thereof according to a second embodiment of the present invention with reference to drawings.

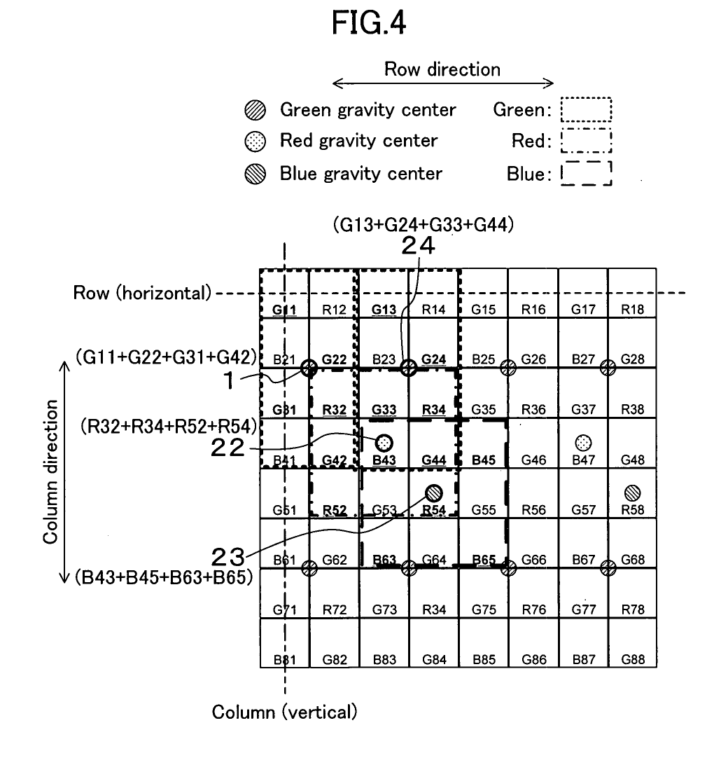

FIG. 4 is an image diagram showing a pixel addition pattern of the solid-state imaging device and the driving method thereof according to the second embodiment of the present invention. As shown in FIG. 4, a color filter array is a Bayer array, for example, in which a filter pixel held by an R filter on both horizontal sides is made to be Gr, and a filter pixel held by a B filter on both horizontal sides is made to be Gb for convenience of explaining an operation, but Gr and Gb are the same color in practice.

In FIG. 4, green (hereinafter referred to as G) G11, G22, G31, and G42 are formed into a first G group; G13, G24, G33, and G44 are formed into a second G group; red (hereinafter referred to as R) R32, R34, R52, and R54 are formed into an R group; and blue (hereinafter referred to as B) B43, B45, B63, and B65 are formed into a B group, in order to perform pixel addition of four pixels.

Accordingly, if pixel addition is performed in the solid-state imaging device according to the second embodiment of the present invention as shown in FIG. 4, each of gravity centers including the G1 gravity center 1, the R gravity center 22, the B gravity center 23, and the G2 gravity center 24 can be arranged without being partial relative to each of a group of adjacent gravity centers.

Furthermore, in the solid-state imaging device according to the second embodiment of the present invention, an upward deviation of two pixels was performed to obtain the G2 gravity center 24 in comparison with the solid-state imaging device according to the first embodiment of the present invention, so that it is possible to obtain a much higher resolution in the lateral direction.

In the solid-state imaging device according to the second embodiment of the present invention, resolution can be improved in the longitudinal direction by performing a signal process using the R gravity center 22 and the B gravity center 23.

Explained next will be a device configuration of the solid-state imaging device according to the second embodiment of the present invention. In the solid-state imaging device according to the second embodiment of the present invention, it is possible to employ any of first to fourth configurations to be described below.

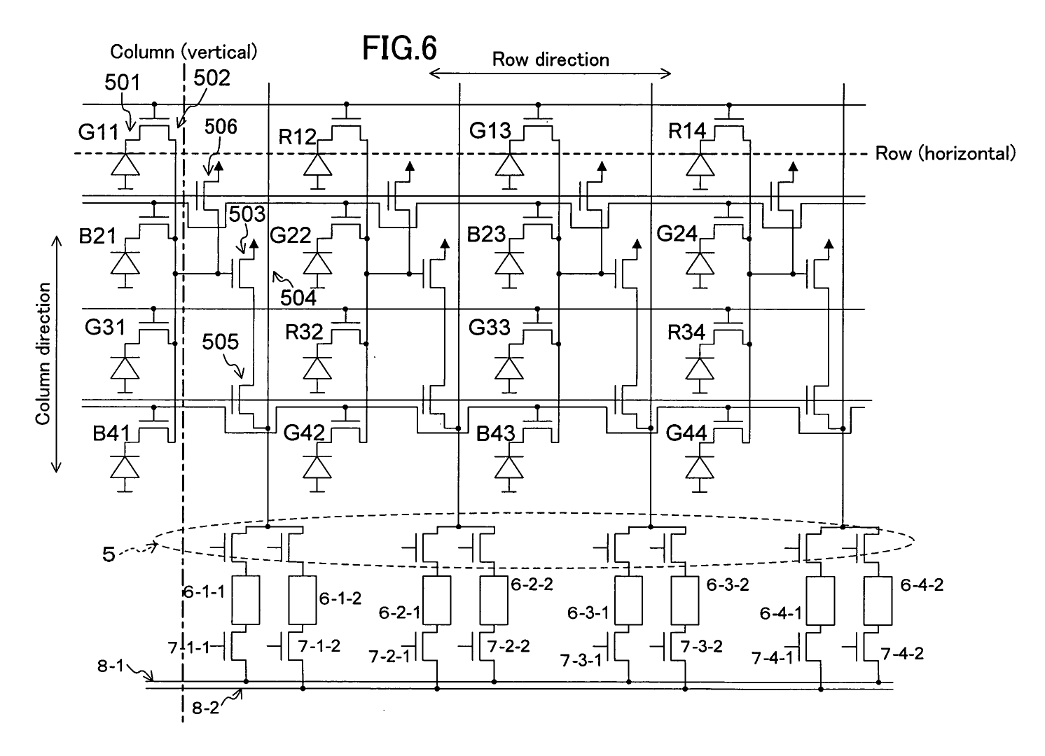

FIG. 6 is used to explain a first configuration of the solid-state imaging device according to the second embodiment of the present invention, in which pixel addition as shown in FIG. 4 is performed.

In FIG. 6, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 504 via the selection transistor 505. A signal voltage appeared on the vertical signal line 504 is temporarily stored in the signal storage capacities 6-1-1, 6-1-2 . . . 6-n-1, and 6-n-2 by passing through the group of the signal distribution transistors 5. Thereafter, the horizontal switches 7-1-1, 7-1-2 . . . 7-n-1, and 7-n-2 are successively turned on, so that signals are read out from the horizontal signal lines 8-1 and 8-2 successively. Electric charge transferred to the gate electrode of the amplifier transistor 503 is ejected by turning on the reset transistor 506.

Due to simultaneous readout of two lines of G11, R12, . . . and G31, R32, . . . , added signals of G11 and G31, R12 and R32, G13 and G33, and R14 and R34 are stored in the signal storage capacities 6-1-1, 6-2-1, 6-3-1, and 6-4-1, respectively, by turning on a switch on a left side of two switches provided in one of vertical signal lines in the group of signal distribution transistors 5.

Next, the horizontal switches 7-2-1 and 7-4-1 are simultaneously turned on to output a signal of addition of R12, R32, R14, and R34 from the second horizontal signal line 8-2.

Next, two lines of B21, G22, . . . and B41, G42 . . . are simultaneously read out, and a switch on a right side of two switches provided in one of the vertical signal lines in the group of the signal distribution transistors 5 is turned on, so that added signals of B21 and B41, G22 and G42, B23 and B43, and G24 and G44 are stored in the signal storage capacities 6-1-2, 6-2-2, 6-3-2, and 6-4-2, respectively.

Next, the horizontal switches 7-1-2 and 7-3-2 are simultaneously turned on to output a signal of addition of B21, B41, B23, and B43 from the second horizontal signal line 8-2.

Next, the horizontal switches 7-1-1 and 7-2-2 are simultaneously turned on to output a signal of addition of G11, G31, G22, and G44 from the first horizontal signal line 8-1. Furthermore, the horizontal switches 7-3-1 and 7-4-2 are simultaneously turned on to output a signal of addition of G13, G33, G24, and G44 from the first horizontal signal line 8-1.

Moreover, in the solid-state imaging device according to the second embodiment of the present invention, a signal of G11+G31 stored in the signal storage capacity 6-1-1 and a signal of G13+G33 stored in the signal storage capacity 6-3-1 are not read out for once in the first-time simultaneous readout of the two lines of G11, R12, . . . and G31, R32 . . . , and the subsequent two lines of B21, G22, . . . and B41, G42 . . . are simultaneously read out instead.

Due to this device and driving, the solid-state imaging device according to the second embodiment of the present invention is capable of performing readout by waiting for the subsequent G signals of G22+G42 and G24+G44 to be stored in the horizontal storage capacities, which allows for readout by adding G11+G31 and G22+G42.

Addition of G13+G33 and G24+G44 is driven in the same manner as the above stated addition of G11+G31 and G22+G42.

In driving the above stated addition of G11+G31 and G22+G42, the horizontal switches 7-2-1 and 7-4-1 (R signals) are turned on in the first readout, while turning on the horizontal switches 7-1-2 and 7-3-2 (B signals), the horizontal switches 7-1-1 and 7-2-2 (G1 signals), and the horizontal switches 7-3-1 and 7-4-2 (G2 signals) in the second readout, and these processes are repeated alternately, in which an amount of signals is occasionally different between the first readout and the second readout.

In the case of having a different amount of signals between the first readout and the second readout, the horizontal switches 7-2-1 and 7-4-1 (R signals), and the horizontal switches 7-1-1 and 7-2-2 (G1 signals) are turned on in the first readout, while turning on the horizontal switches 7-1-2 and 7-3-2 (B signals), and the horizontal switches 7-3-1 and 7-4-2 (G2 signals) in the second readout, and if these processes are driven to be repeated alternately, a readout array as shown in FIG. 4 is realized due to a vertical deviation of two pixels in readout of green (G) pixels in every two lines.

That is, if the number of signals is different between the first readout and the second readout, this problem can be solved by switching readout between the horizontal switches 7-2-1 and 7-4-1 (R signals) of the first readout and the horizontal switches 7-1-2 and 7-3-2 (B signals) of the second readout.

Two pixels are simply added in the R and B pixels in the longitudinal direction, which allows for readout by single addition in the longitudinal direction, so that a signal stored in the horizontal storage capacity can be read out immediately after turning on the horizontal switch (performing addition in the horizontal direction).

However, four pixels are added in the G pixels in the longitudinal direction, amd thereby a signal obtained by single addition in the longitudinal direction cannot be read out immediately after being stored in the storage capacity by turning on the horizontal switch. That is, it is required to wait for a subsequent signal to be stored in the signal storage capacity by operating subsequent vertical addition once again.

However, in the solid-state imaging device according to the second embodiment of the present invention, it is not required to wait for G signals by causing a deviation of a line to read out in every two adjacent lines, in order to realize readout of G signals in a staggered or checkered pattern.

Although a deviation of R or B in the horizontal direction is required, if the horizontal switches 7-4-1 and 7-6-1 (not shown) are turned on simultaneously in place of turning on the horizontal switches 7-2-1 and 7-4-1 simultaneously when an R signal is read out, readout of R signals can be easily realized.

Furthermore, the horizontal switches 7-3-2 and 7-5-2 (not shown) shall be simultaneously turned on in place of turning on the horizontal switches 7-1-2 and 7-3-2 when a B signal is read out.

As explained above, in the first configuration of the solid-state imaging device according to the second embodiment of the present invention, a combination of the G4 pixels and a combination of the R4 pixels and the B4 pixels can be freely realized by simply changing timing and combinations of reading out the horizontal switches.

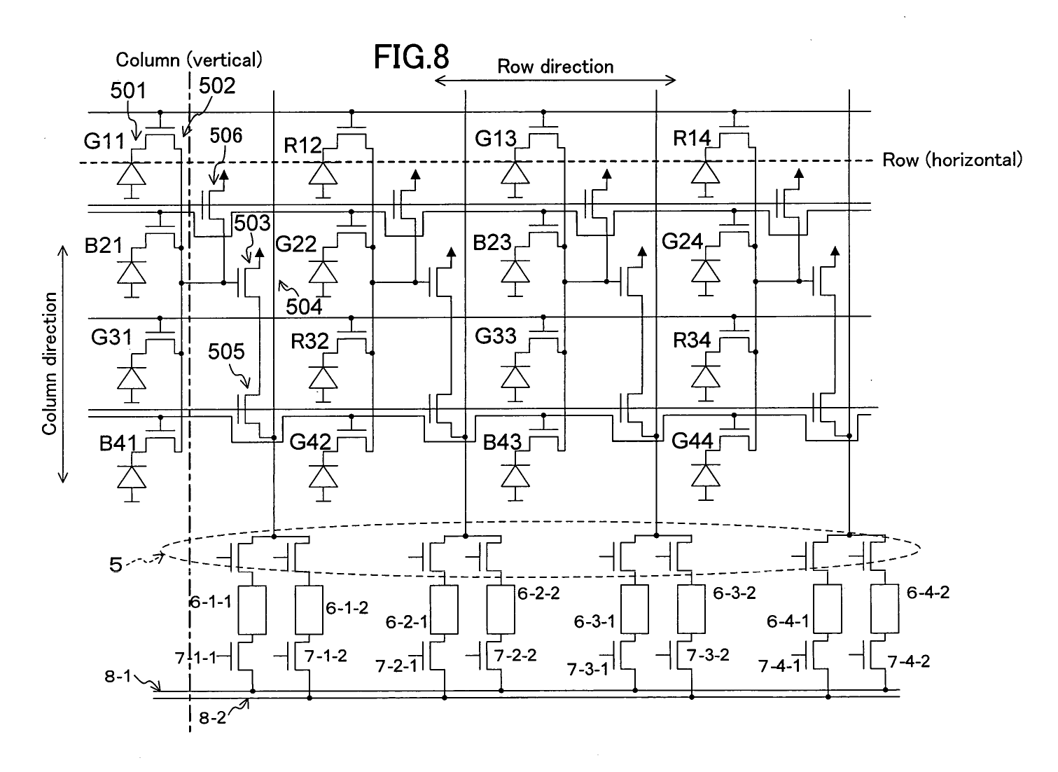

Next, FIG. 8 is used to explain a second configuration of the solid-state imaging device according to the second embodiment of the present invention, in which pixel addition as shown in FIG. 4 is performed.

As shown in FIG. 8, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 504 via the selection transistor 505. A signal voltage appeared on the vertical signal line 504 is temporarily stored in the signal storage capacities 6-1-1, 6-1-2 . . . 6-n-1, and 6-n-2 by passing through the group of the signal distribution transistors 5. Thereafter, the horizontal switches 7-1-1, 7-1-2 . . . 7-n-1, and 7-n-2 are successively turned on, so that signals are read out from the horizontal signal lines 8-1 and 8-2 successively. Electric charge transferred to the gate electrode of the amplifier transistor 503 is ejected by turning on the reset transistor 506. The difference from the first configuration shown in FIG. 6 is that a pixel to read out is switched in each row.

In the case of the second configuration, there is an advantage that a column which exclusively outputs G (green) can be separated from columns which output R (red) and B (blue) in the pixel configuration and pixel addition as shown in FIG. 4.

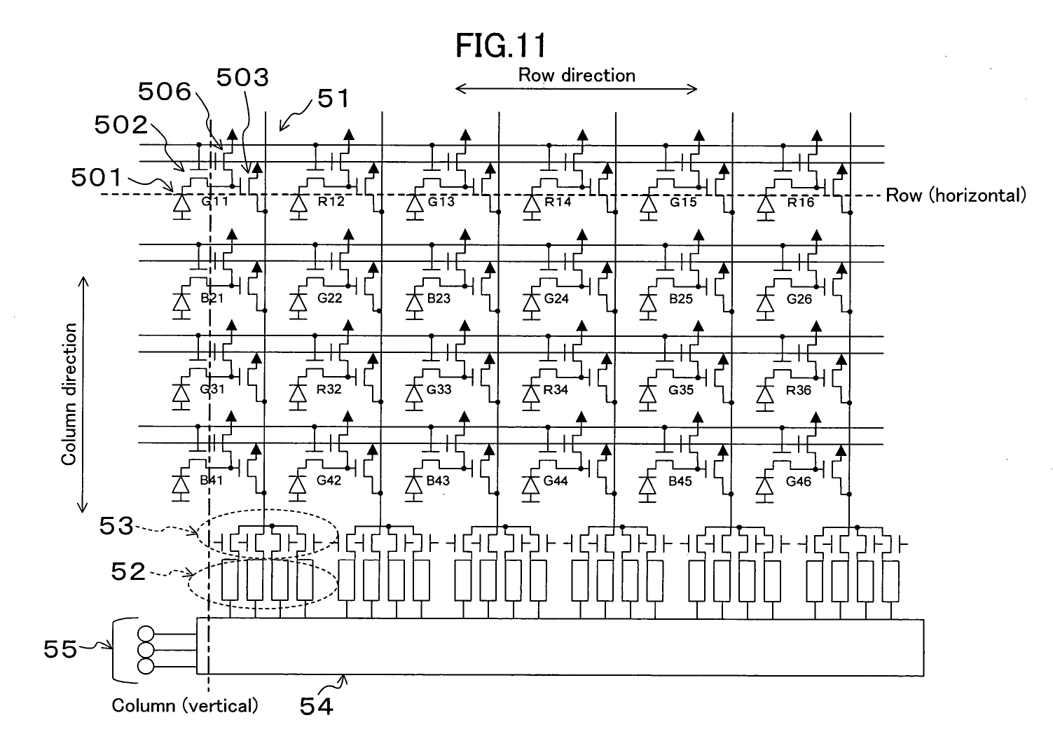

Next, FIG. 11 is used to explain a third configuration of the solid-state imaging device according to the second embodiment of the present invention, in which pixel addition as shown in FIG. 4 is performed.

In FIG. 11, the solid-state imaging device is an amplification-type solid-state imaging device, and light which was made incident to the photo diode 501 provided internally in a silicon substrate is photoelectrically converted and stored as electric charge. Stored electric charge is also transferred to a gate electrode of the amplifier transistor 503 after having been stored for a predetermined period of time by opening the transfer gate 502, and an amplified signal is outputted as a signal voltage from the vertical signal line 51.

Although FIG. 11 does not show a selection transistor, a selection transistor may be provided in the third configuration.

Explanation will be made using FIG. 23 for the solid-state imaging device according to this embodiment in the case of providing no selection transistor. FIG. 23 is a circuit configuration diagram of a photoelectric conversion cell in an MOS-type image sensor according to the first embodiment of the present invention, wherein: 201 is a PD portion to perform photoelectric conversion; 202 is an FD portion to store photoelectrically converted electric charge; 203 is a transfer gate to transfer electric charge to the FD portion 202; 204 is a reset gate to sweep electric charge of the FD portion 202; 205 is a pixel amplifier to detect electric charge of the FD portion 202; 206 is a load transistor to form a source follower amplifier in cooperation with the pixel amplifier 205; 207 is a common power line to apply a common power voltage signal VDDCEL to the photoelectric conversion cell; 208 is a read pulse line to apply a read signal READ to the transfer gate 203; 209 is a reset pulse line to which a rest signal RESET for sweeping electric charge of the FD portion 202 is applied; 210 is an output signal line to transmit a pixel signal VD detected in the pixel amplifier 205; 211 is a load gate line to apply a load gate signal LGCEL to a gate of the load transistor 206; and 212 is a source common power line to commonly apply a source power voltage signal SCEL to the load transistor 206.

Moreover, as shown in FIG. 11, the vertical signal line 51 is provided to correspond to each column one by one, and the group of the four signal storage capacities 52 is provided to correspond to this single output line. Furthermore, it is the group of the signal distribution switches 53 to distribute an output signal of the single vertical signal line 51 into the group of the four signal storage capacities 52. Addition of four pixels in the column direction and addition in the row direction are also performed by the horizontal multiplexer 54, so as to be distributed to the group of the horizontal output lines 55.

As explained above, the third configuration has the horizontal storage capacities provided twice as many as those of the first and second configurations, which results in a simple device configuration because signals successively read out in each column can be stored in this storage capacities successively, so that there is an advantage of allowing for pixel addition as shown in FIG. 4 even in this simple configuration.

Furthermore, a combination of four G pixels and a combination of four R pixels and four B pixels can be freely realized in this embodiment by the control method of the horizontal multiplexer including the horizontal switches, in the same manner as the first and second configurations as explained above.

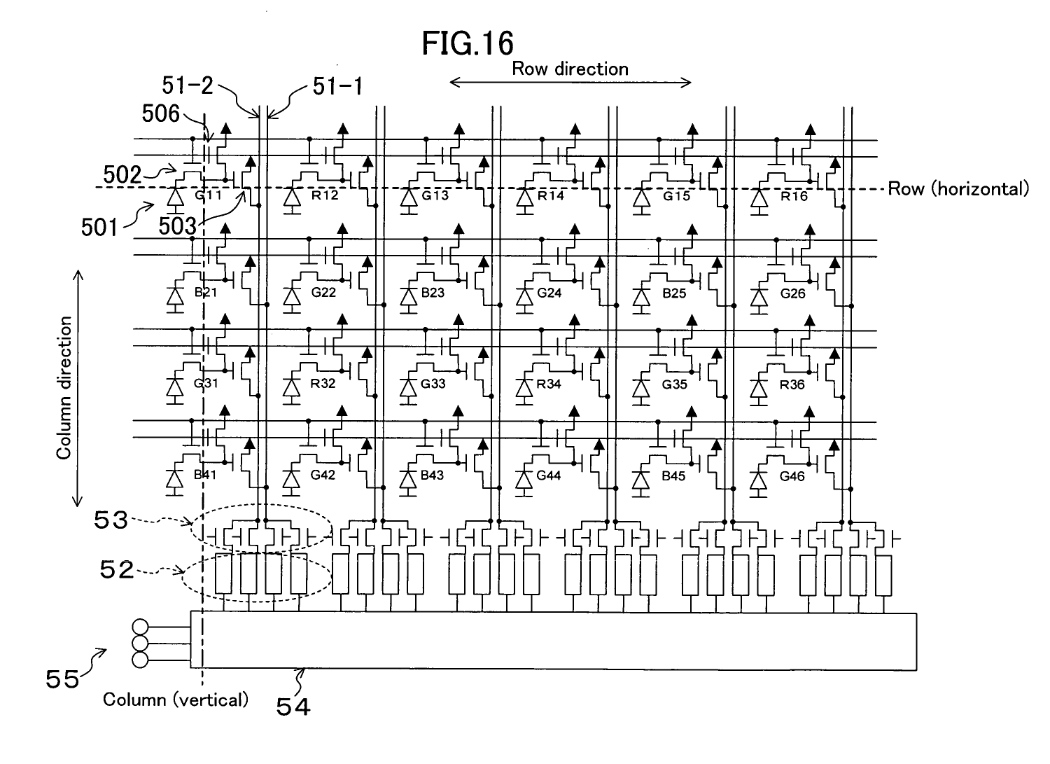

Next, FIG. 16 is used to explain a fourth configuration of the solid-state imaging device according to the second embodiment of the present invention, in which pixel addition as shown in FIG. 4 is performed.

As shown in FIG. 16, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 51-1 or 52-2.

Two vertical signal lines, 51-1 and 51-2, are provided to correspond to an odd-number row and an even-number row, and two horizontal storage capacities and two horizontal switches are provided for each of the vertical signal lines 51-1 and 51-2. It is the same as the third configuration that a total of the four horizontal storage capacities and a total of the four horizontal switches are provided for a single column. Addition of four pixels in the column direction and addition in the row direction are also performed by the horizontal multiplexer 54, so as to be distributed to the group of the horizontal output lines 55.

As explained above, the fourth configuration has an advantage of allowing for improvement of a readout speed over the remaining configurations, because signals can be read out through the two vertical signal lines by selecting and operating two adjacent columns simultaneously.

As explained above by using the drawings of FIG. 4, FIG. 6, FIG. 8, FIG. 11, and FIG. 16, the solid-state imaging device according to the second embodiment of the present invention has the following superior characteristics.

First, the solid-state imaging device according to the second embodiment of the present invention is an MOS-type solid-state imaging device, and not operated in the same manner as a CCD-type solid-state imaging device, which reads out a signal by an electric charge transfer, and thereby if these devices are compared assuming that no pixel addition is performed, an MOS-type solid-state imaging device is capable of reading out an electric charge signal faster than a CCD-type solid-state imaging device in general.

Therefore, in the CCD-type solid-state imaging device disclosed in the conventional technique (Japanese Patent Application Publication No. 2004-312140), it is necessary to add many pixels, or more specifically, nine pixels are added for high-speed implementation.

Meanwhile, in the solid-state imaging device according to the second embodiment of the present invention, high-speed implementation is realized by pixel addition as shown in FIG. 4 in the same manner as the conventional technique (Japanese Patent Application Publication No. 2004-312140), in which signal electric charge can be read out faster than the CCD-type solid-state imaging device disclosed in the conventional technique (Japanese Patent Application Publication No. 2004-312140) even in pixel addition of four pixels, which is smaller than nine-pixel addition, due to the MOS-type configuration.

Moreover, in the solid-state imaging device according to the second embodiment of the present invention, it is possible to obtain a resolution which is higher than that of the solid-state imaging device disclosed in the conventional technique (Japanese Patent Application Publication No. 2004-312140), due to pixel addition of four pixels as shown in FIG. 4, which is smaller than nine-pixel addition.

Accordingly, the solid-state imaging device according to the second embodiment of the present invention is capable of obtaining higher resolution characteristics and higher readout speed characteristics than those of the conventional technique (Japanese Patent Application Publication No. 2004-312140).

Furthermore, the solid-state imaging device according to the second embodiment of the present invention is capable of obtaining superior image characteristics with less moires or fault resolutions than those of the solid-state imaging device disclosed in the conventional technique (Japanese Patent Application Publication No. 2001-36920), so that it is possible to prevent significant decrease of a vertical resolution with respect to a horizontal resolution caused by imbalance in pixel sampling density between the horizontal direction and the vertical direction, and prevent substantial sensitivity decrease because a signal of a pixel in a column which is not read out is not ejected.

In the solid-state imaging device according to the second embodiment of the present invention, an image obtained without performing pixel addition (hereinafter referred to as a first image) and an image obtained by performing pixel addition (hereinafter referred to as a second image) in the same solid-state imaging device can be both outputted as a still picture. This method is particularly effective for a single-lens digital still camera, which does not photograph a motion picture in general.

Moreover, the solid-state imaging device according to the second embodiment of the present invention is capable of outputting both the first image and the second image as a motion picture. The solid-state imaging device according to the second embodiment of the present invention is further capable of outputting the first image as a still picture and the second image as a motion picture, in the same manner as the conventional technique. The solid-state imaging device according to the second embodiment of the present invention is similarly capable of outputting the first image as a motion picture and the second image as a still picture.

Although the solid-state imaging device according to the second embodiment of the present invention was exhibited by using the MOS-type solid-state imaging device as an example, it can be also realized by a solid-state imaging device which is not operated in the same manner as a CCD-type solid-state imaging device for reading out a signal by an electric charge transfer, examples including sensors of any types such as BASIS, CMOS sensor, SIT sensor, CMD, and AMI.

Although the solid-state imaging device according to the second embodiment of the present invention was explained in the case of four-pixel addition using FIG. 4, it is also possible to add pixels larger than four pixels (e.g., nine-pixel addition) in a solid-state imaging device with an extremely large number of pixels (e.g., 10 million pixels or larger) by arranging the position of gravity centers of respective colors in a relationship similar to that of FIG. 4.

### Third Embodiment

Explained below will be a solid-state imaging device and a driving method thereof according to a third embodiment of the present invention with reference to drawings.

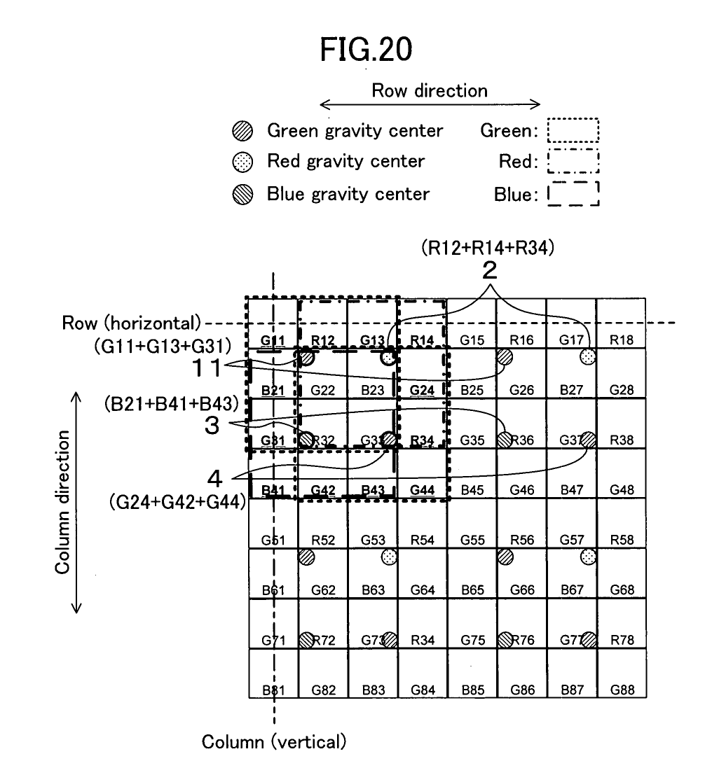

FIG. 20 is an image diagram showing a pixel addition pattern of the solid-state imaging device and the driving method thereof according to the third embodiment of the present invention. As shown in FIG. 20, a color filter array is a Bayer array for example, in which a filter pixel held by an R filter on both horizontal sides is made to be Gr, and a filter pixel held by a B filter on both horizontal sides is made to be Gb for convenience of explaining an operation, but Gr and Gb are the same color in practice.

As shown in FIG. 20, green (hereinafter referred to as G) G11, G13, G31, and G33 are formed into a G1 group in which G11, G13, and G31 are exclusively added; red (hereinafter referred to as R) R12, R14, R32, and R34 are formed into an R group in which R12, R14, and R34 are exclusively added; G22, G24, G42, and G44 are formed into a G2 group in which G24, G42, and G44 are exclusively added; and blue (hereinafter referred to as B) B21, B23, B41, and B43 are formed into a B group in which B21, B41, and B43 are exclusively added. The solid-state imaging device according to this embodiment performs pixel addition of three pixels as stated above. Due to the pixel addition, a gravity center of the first G group is made to be a G1 gravity center 11, a gravity center of the R group is made to be an R gravity center 2, a gravity center of the B group is made to be a B gravity center 3, and a gravity center of the second G group is made to be a G2 gravity center 4.

Accordingly, if pixel addition is performed in the solid-state imaging device according to the third embodiment of the present invention as shown in FIG. 20, each of the gravity centers including the G1 gravity center, the R gravity center, the B gravity center, and the G2 gravity center can be arranged without being partial relative to each of a group of adjacent gravity centers.

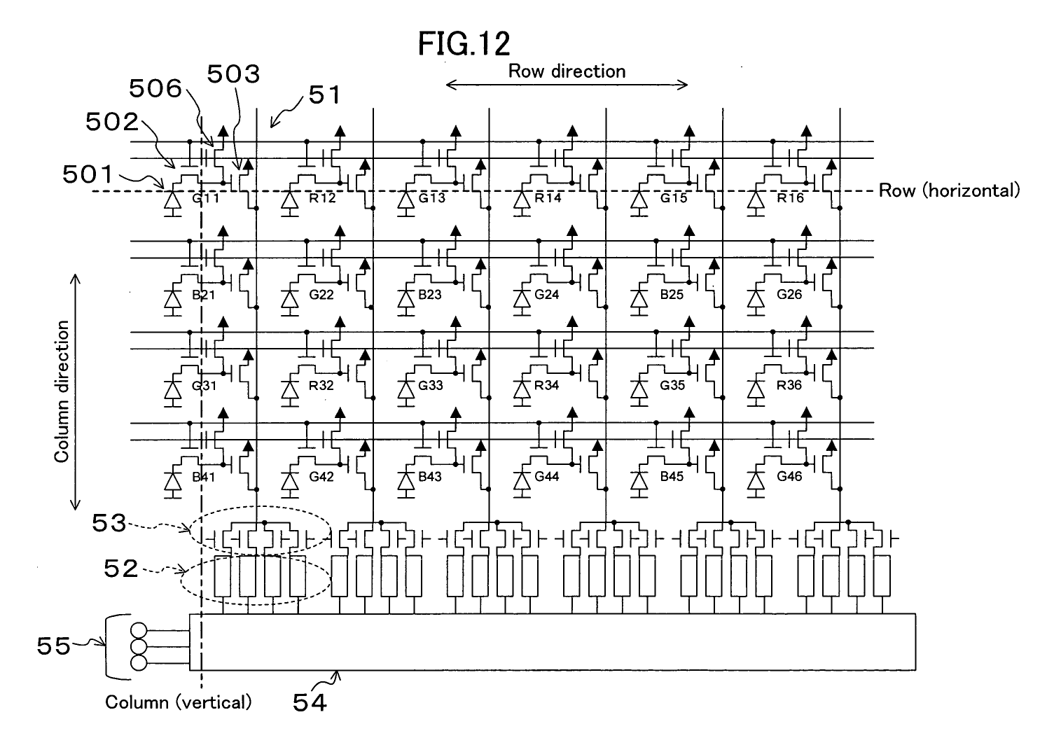

Explained next will be a device configuration of the solid-state imaging device according to the third embodiment of the present invention. In the solid-state imaging device according to this embodiment, it is possible to employ any of first and second configurations to be described below. FIG. 12 is used to explain a first configuration of the solid-state imaging device according to this embodiment, in which pixel addition as shown in FIG. 20 is performed.

As shown in FIG. 12, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 51 via a selection transistor.

Moreover, the vertical signal line 51 is provided to correspond to each column one by one, and the group of the four signal storage capacities 52 is provided to correspond to this single output line. Furthermore, it is the group of the signal distribution switches 53 to distribute an output of the single vertical signal line 51 into the group of the four signal storage capacities 52. Addition of four pixels in the column direction and addition in the row direction are also performed by the horizontal multiplexer 54, so that an added signal is distributed to the group of the horizontal output lines 55. As it will be understood from this configuration, it is possible to store a signal of four pixels in the vertical direction while signals can be freely added in the horizontal direction by the horizontal multiplexer. Accordingly, pixel addition according to the present invention is made possible.

Although FIG. 12 does not show a selection transistor, a selection transistor may be provided in the first configuration.

Explanation will be made using FIG. 23 for the solid-state imaging device according to this embodiment in the case of providing no selection transistor. FIG. 23 is a circuit configuration diagram of a photoelectric conversion cell in an MOS-type image sensor according to the third embodiment of the present invention. The solid-state imaging device in this embodiment has a configuration which is common to that of the first embodiment. In FIG. 23, 201 is a PD portion to perform photoelectric conversion; 202 is an FD portion to store photoelectrically converted electric charge; 203 is a transfer gate to transfer electric charge to the FD portion 202; 204 is a reset gate to sweep electric charge of the FD portion 202; 205 is a pixel amplifier to detect electric charge of the FD portion 202; 206 is a load transistor to form a source follower amplifier in cooperation with the pixel amplifier 205; 207 is a common power line to apply a common power voltage signal VDDCEL to the photoelectric conversion cell; 208 is a read pulse line to apply a read signal READ to the transfer gate 203; 209 is a reset pulse line to which a rest signal RESET for sweeping electric charge of the FD portion 202 is applied; 210 is an output signal line to transmit a pixel signal VD detected in the pixel amplifier 205; 211 is a load gate line to apply a load gate signal LGCEL to a gate of the load transistor 206; and 212 is a source common power line to commonly apply a source power voltage signal SCEL to the load transistor 206.

As explained above, the number of the horizontal storage capacities provided in a first configuration is doubled, which results in a simple device configuration because signals successively read out in each column can be stored in this storage capacities successively, so that there is an advantage of allowing for pixel addition as shown in FIG. 20 even in this simple configuration.

Explained next will be a method in which three pixels out of four pixels are exclusively added in pixel addition as shown in FIG. 20 using the first configuration in the solid-state imaging device according to the third embodiment of the present invention. It is assumed here that three pixels excluding G33 out of four pixels of G11, G13, G31, and G33 are added.

First, there are three kinds of methods including first, second and third methods to perform pixel addition in this embodiment.

The first method is a method to control the group of the signal distribution switches 53. To be more specific, when G33 is read from a pixel and a signal thereof is transmitted to the vertical signal line, a switch corresponding to G33 is controlled so as not to be turned on. Therefore, the signal of G33 is not transmitted to the group of the signal storage capacities 52. Accordingly, three signals of G11, G13, and G31 except for G33 are exclusively added.

The second method is a method to control by the horizontal multiplexer 54. Horizontal switches connected to the group of the signal storage capacities 52 are incorporated in the horizontal multiplexer. Therefore, a horizontal switch connected to a horizontal storage capacity which stores G33 is exclusively controlled so as not to be turned on. Accordingly, three signals of G11, G13, and G31 except for G33 are exclusively added.

Furthermore, the third method is a method to use the first and second methods in combination. It is because an actual signal stored in a capacity which was supposed to be used for storing G33 is occasionally difficult to confirm in the method to control the signal distribution switches, and there is a case that electric charge stored therein becomes noise. Accordingly, the method to control the horizontal multiplexer 54, or a combination of the above-stated two methods is considered to be a satisfactory selection. A method to add three R pixels and three B pixels can be carried out in substantially similar methods exhibited in the first to third methods. The first configuration has an advantage of easy understanding of an operation with a simple configuration, in comparison with a second configuration to be described below.

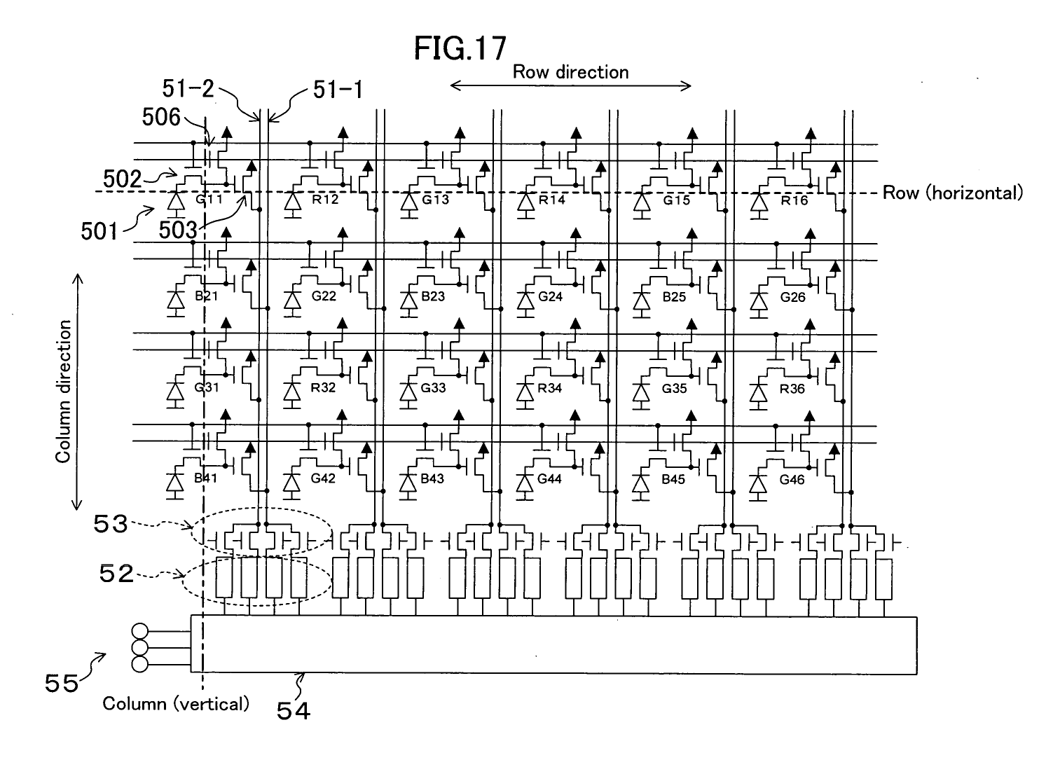

Next, FIG. 17 is used to explain a second configuration of the solid-state imaging device according to the third embodiment of the present invention, in which pixel addition as shown in FIG. 20 is performed.

That is, light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 51-1 or 51-2. Moreover, two vertical signal lines, 51-1 and 51-2, are provided to correspond to an odd-number row and an even-number row. Furthermore, two horizontal storage capacities and two horizontal switches are provided for each of the vertical signal lines 51-1 and 51-2. It is the same with the first configuration that a total of the four horizontal storage capacities and a total of the four horizontal switches are provided for a single column. Addition of four pixels in the column direction and addition in the row direction are also performed by the horizontal multiplexer 54, and an added signal is distributed to the group of the horizontal output lines 55.

As explained above, the second configuration has an advantage of allowing for improvement of a readout speed over the remaining configuration, because signals can be read out through the two vertical signal lines by selecting and operating two adjacent columns simultaneously.

A method to add three pixels in this configuration is similar to that of the first configuration. It is assumed here that three pixels excluding G33 out of four pixels of G11, G13, G31, and G33 are added.

Explained next will be a method to exclusively add three pixels out of four pixels in pixel addition as shown in FIG. 20 using the second configuration of the solid-state imaging device according to the third embodiment of the present invention. It is assumed here that three pixels excluding G33 out of four pixels of G11, G13, G31, and G33 are added.

First, there are three kinds of methods including first, second and third methods to perform pixel addition in this embodiment.

The first method is a method to control the group of the signal distribution switches 53. To be more specific, when G33 is read from a pixel and a signal thereof is transmitted to the vertical signal line, a switch corresponding to G33 is controlled so as not to be turned on. Therefore, the signal of G33 is not transmitted to the group of the signal storage capacities 52. Accordingly, three signals of G11, G13, and G31 except for G33 are exclusively added.

The second method is a method to control by the horizontal multiplexer 54. Horizontal switches connected to the group of the signal storage capacities 52 are incorporated in the horizontal multiplexer. Therefore, a horizontal switch connected to a horizontal storage capacity which stores G33 is exclusively controlled so as not to be turned on. Accordingly, three signals of G11, G13, and G31 except for G33 are exclusively added.

Furthermore, the third method is a method to use the first and second methods in combination. It is because an actual signal stored in a capacity which was supposed to be used for storing G33 is occasionally difficult to confirm in the method to control the signal distribution switches, and there is a case that electric charge stored therein becomes noise. Accordingly, the method to control the horizontal multiplexer 54, or a combination of the above-stated two methods is considered to be a satisfactory selection. A method to add three R pixels and three B pixels can be carried out in substantially similar methods exhibited in the first to third methods.

As explained above, the second configuration has an advantage of improving a readout speed over the first configuration, because it is possible to deal with signals of vertically adjacent two pixels simultaneously by having the two vertical signal lines.

As explained above by using the drawings of FIG. 20, FIG. 12, and FIG. 17, the solid-state imaging device according to the third embodiment of the present invention has following superior characteristics.

First, the solid-state imaging device according to the third embodiment of the present invention is an MOS-type solid-state imaging device, and not operated in the same manner with a CCD-type solid-state imaging device which reads out a signal by an electric charge transfer, thereby if these devices are compared assuming that no pixel addition is performed, an MOS-type solid-state imaging device is capable of reading out an electric charge signal faster than a CCD-type solid-state imaging device in general.

Therefore, in the CCD-type solid-state imaging device disclosed in the conventional technique (Japanese Patent Application Publication No. 2004-312140), it is necessary to add many pixels, or more specifically, nine pixels are added for high-speed implementation.

Meanwhile, in the solid-state imaging device according to the third embodiment of the present invention, high-speed implementation is realized by pixel addition as shown in FIG. 20 in the same manner with the conventional technique (Japanese Patent Application Publication No. 2004-312140), in which signal electric charge can be read out faster than the CCD-type solid-state imaging device disclosed in the conventional technique (Japanese Patent Application Publication No. 2004-312140), even in pixel addition of three pixels which is smaller than nine-pixel addition, due to the MOS-type configuration.

Moreover, in the solid-state imaging device according to the third embodiment of the present invention, it is possible to obtain a resolution which is higher than that of the solid-state imaging device disclosed in the conventional technique (Japanese Patent Application Publication No. 2004-312140), due to pixel addition of three pixels as shown in FIG. 20 which is smaller than nine-pixel addition.

Accordingly, in the solid-state imaging device according to the third embodiment of the present invention, improvement of resolution characteristics and implementation of high-speed readout can be recognized more than the conventional technique (Japanese Patent Application Publication No. 2004-312140).

Furthermore, the solid-state imaging device according to the third embodiment of the present invention is capable of obtaining superior image characteristics with less moires or fault resolutions than those of the solid-state imaging device disclosed in the conventional technique (Japanese Patent Application Publication No. 2001-36920), so that it is possible to prevent significant decrease of a vertical resolution with respect to a horizontal resolution caused by imbalance in pixel sampling density between the horizontal direction and the vertical direction, and prevent substantial sensitivity decrease because a signal of a pixel in a column which is not read out is not ejected.

In the solid-state imaging device according to the third embodiment of the present invention, it is possible to weight addition by differentiating the size of each capacity in the group of the signal storage capacities 52 in the configurations of FIG. 12 and FIG. 17.

In the solid-state imaging device according to the third embodiment of the present invention, an image obtained without performing pixel addition (hereinafter referred to as a first image) and an image obtained by performing pixel addition (hereinafter referred to as a second image) in the same solid-state imaging device can be both outputted as a still picture. This method is particularly effective for a single-lens digital still camera which does not photograph a motion picture in general.

Moreover, the solid-state imaging device according to this embodiment is capable of outputting both the first image and the second image as a motion picture. The solid-state imaging device according to this embodiment is further capable of outputting the first image as a still picture and the second image as a motion picture, in the same manner with the conventional techniques. Furthermore, the solid-state imaging device according to the third embodiment of the present invention is capable of outputting the first image as a motion picture and the second image as a still picture.

Although the solid-state imaging device according to the third embodiment of the present invention was exhibited by using the MOS-type solid-state imaging device as an example, it can be also realized by a solid-state imaging device which is not operated in the same manner with a CCD-type solid-state imaging device for reading out a signal by an electric charge transfer, examples including sensors of any types such as BASIS, CMOS sensor, SIT sensor, CMD, and AMI.

Although the solid-state imaging device according to the third embodiment of the present invention was explained in the case of three-pixel addition using FIG. 20, it is also possible to add pixels larger than four pixels (ex. five-pixel addition) in a solid-state imaging device with an extremely large number of pixels (ex. 10 million pixels or larger) by arranging the position of gravity centers of respective colors in a relationship similar to that of FIG. 20.

### Fourth Embodiment

Explained below will be a solid-state imaging device and a driving method thereof according to a fourth embodiment of the present invention with reference to drawings.

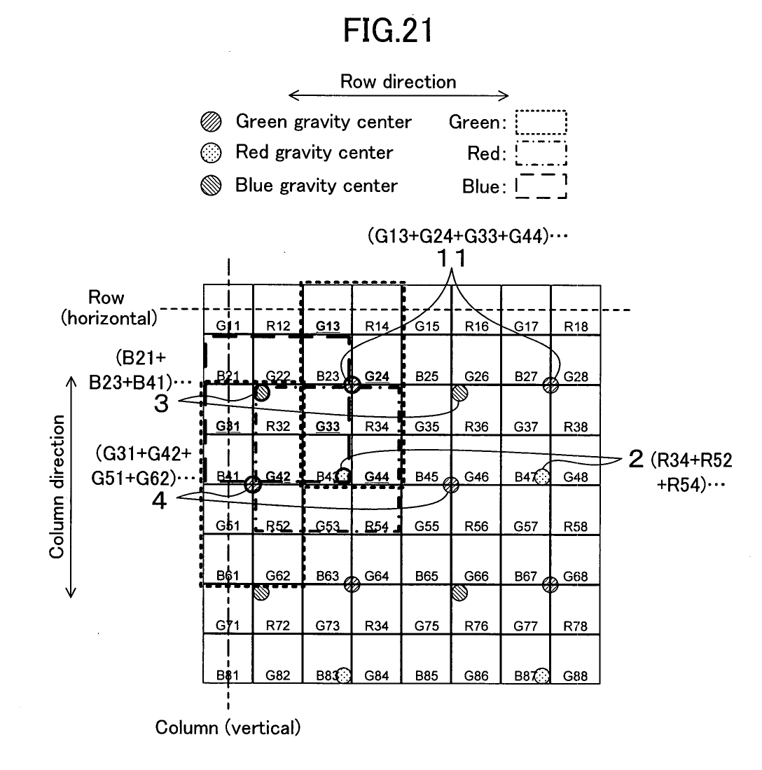

FIG. 21 is an image diagram showing a pixel addition pattern of the solid-state imaging device and the driving method thereof according to the fourth embodiment of the present invention. As shown in FIG. 21, a color filter array is a Bayer array for example, in which a filter pixel held by an R filter on both horizontal sides is made to be Gr, and a filter pixel held by a B filter on both horizontal sides is made to be Gb for convenience of explaining an operation, but Gr and Gb are the same color in practice.

As shown in FIG. 21, in the driving method of this embodiment, G13, G24, G33, and G44 are formed into a G1 group in which the entire four pixels are added; B21, B23, B41, and B43 are formed into a B group in which B21, B41, and B23 are exclusively added; G31, G42, G51, and G62 are formed into a G2 group in which the entire four pixels are added; and R32, R52, R34 and R54 are formed into an R group in which R52, R34, and R54 are exclusively added.

Due to the pixel addition, a gravity center of the first G group is made to be a G1 gravity center 11, a gravity center of the R group is made to be an R gravity center 2, a gravity center of the B group is made to be a B gravity center 3, and a gravity center of the second G group is made to be a G2 gravity center 4.

Accordingly, if pixel addition is performed in the solid-state imaging device according to the fourth embodiment of the present invention as shown in FIG. 21, each of the gravity centers including the G1 gravity center, the R gravity center, the B gravity center, and the G2 gravity center can be arranged without being partial relative to each of a group of adjacent gravity centers.

Furthermore, the G gravity centers obtained after pixel addition are disposed in a checkered array, and a partial arrangement is improved in R and B arrays.

Explained next will be a device configuration of the solid-state imaging device according to the fourth embodiment of the present invention. In the solid-state imaging device according to this embodiment, it is possible to employ any of first and second configurations to be described below.

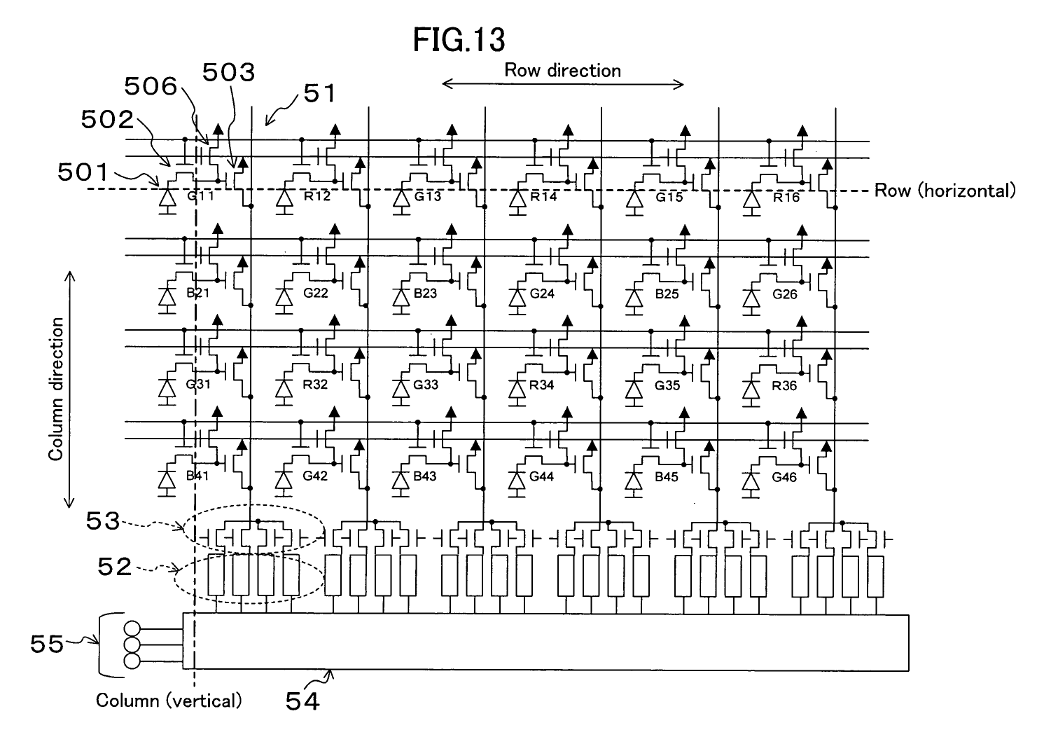

First, FIG. 13 is used to explain a first configuration of the solid-state imaging device according to the fourth embodiment of the present invention, in which pixel addition as shown in FIG. 21 is performed.

As shown in FIG. 13, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 51 via a selection transistor.

Moreover, the vertical signal line 51 is provided in each column, and the group of the four signal storage capacities 52 is provided with respect to the single vertical signal line 51. Furthermore, it is the group of the signal distribution switches 53 to distribute an output signal of the single vertical signal line 51 into the group of the four signal storage capacities 52. Addition of four pixels in the column direction and addition in the row direction are also performed by the horizontal multiplexer 54, so that an added signal is distributed to the group of the horizontal output lines 55. As it will be understood from this configuration, it is possible to store a signal of four pixels in the vertical direction while signals can be freely added in the horizontal direction by the horizontal multiplexer. Accordingly, pixel addition according to the present invention is made possible.

Although FIG. 13 does not show a selection transistor, a selection transistor may be provided in the first configuration.

Explanation will be made using FIG. 23 for the solid-state imaging device according to this embodiment in the case of providing no selection transistor. The solid-state imaging device in the first configuration has a configuration which is common to that of the solid-state imaging device in the first embodiment. In FIG. 23, 201 is a PD portion to perform photoelectric conversion; 202 is an FD portion to store photoelectrically converted electric charge; 203 is a transfer gate to transfer electric charge to the FD portion 202; 204 is a reset gate to sweep electric charge of the FD portion 202; 205 is a pixel amplifier to detect electric charge of the FD portion 202; 206 is a load transistor to form a source follower amplifier in cooperation with the pixel amplifier 205; 207 is a common power line to apply a common power voltage signal VDDCEL to the photoelectric conversion cell; 208 is a read pulse line to apply a read signal READ to the transfer gate 203; 209 is a reset pulse line to which a rest signal RESET for sweeping electric charge of the FD portion 202 is applied; 210 is an output signal line to transmit a pixel signal VD detected in the pixel amplifier 205; 211 is a load gate line to apply a load gate signal LGCEL to a gate of the load transistor 206; and 212 is a source common power line to commonly apply a source power voltage signal SCEL to the load transistor 206. As explained above, the number of the horizontal storage capacities provided in the first configuration is doubled, which results in a simple device configuration because signals successively read out in each column can be stored in this storage capacities successively, so that there is an advantage of allowing for pixel addition as shown in FIG. 21 even in this simple configuration.

Addition of four G pixels can be carried out in a method similar to addition of four G pixels in the first and second embodiments, and addition of three R and B pixels can be realized in a method similar to addition of three R and G pixels in the third embodiment.

As explained above, the first configuration has four of the signal storage capacities to be provided for each of the vertical signal lines disposed in each column, so that four pixels can be freely added in the vertical direction. There is also an advantage of having a simple device configuration and allowing for pixel addition as shown in FIG. 21 even in this simple configuration.

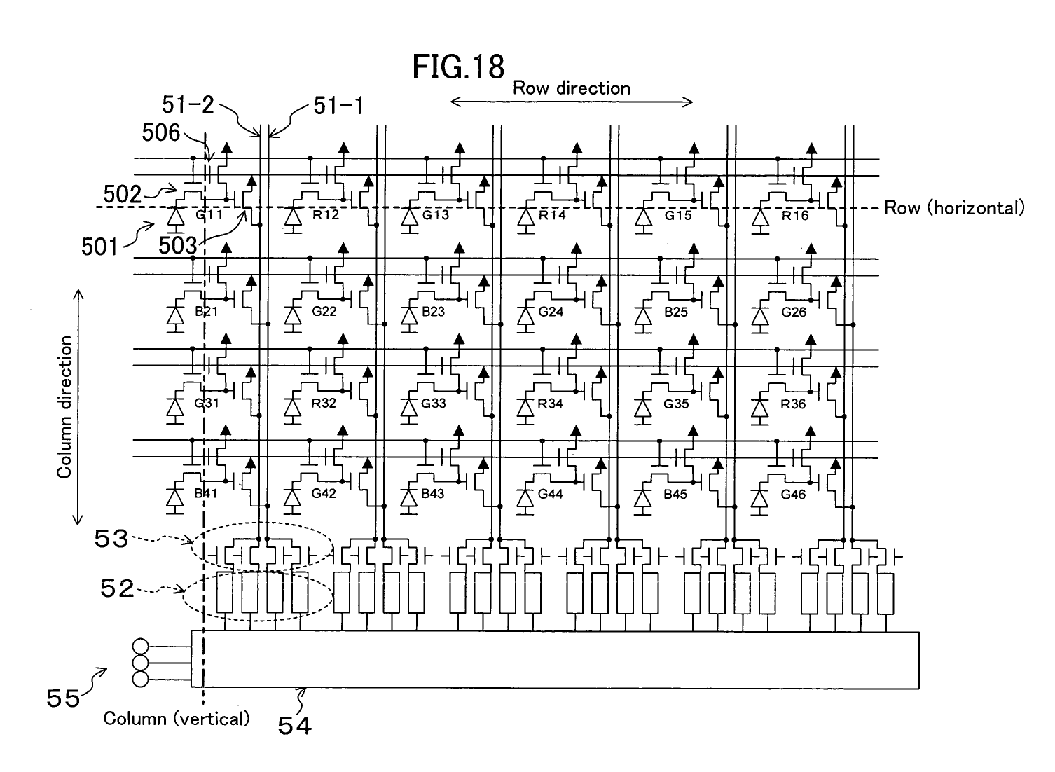

Next, FIG. 18 is used to explain a second configuration of the solid-state imaging device according to the fourth embodiment of the present invention, in which pixel addition as shown in FIG. 21 is performed.

As shown in FIG. 18, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal lines 51-1 and 51-2 via a selection transistor.

Moreover, two vertical signal lines, 51-1 and 51-2, are provided to correspond to an odd-number row and an even-number row. Furthermore, two horizontal storage capacities and two horizontal switches are provided for each of the vertical signal lines 51-1 and 51-2. It is the same with the first configuration that a total of the four horizontal storage capacities and a total of the four horizontal switches are provided for a single column.

Addition of four pixels in the column direction and addition in the row direction are also performed by the horizontal multiplexer 54, and an added signal is distributed to the group of the horizontal output lines 55.

As explained above, the second configuration has an advantage of allowing for improvement of a readout speed over the remaining configuration, because signals can be read out through the two vertical signal lines by selecting and operating two adjacent columns simultaneously.

A method to add signals is also similar to that of the first configuration, and addition of four G pixels here can be carried out by a method similar to addition of four G pixels in the first and second embodiments. Addition of three R and B pixels can also be realized by a method similar to addition of three R and B pixels in the third embodiment.

As explained above, the second configuration has an advantage of allowing for improvement of a readout speed over the first configuration, because it is possible to deal with signals of vertically adjacent two pixels simultaneously by having the two vertical signal lines.

As explained above by using the drawings of FIG. 21, FIG. 13, and FIG. 18, the solid-state imaging device according to the fourth embodiment of the present invention has following superior characteristics.

First, the solid-state imaging device according to the fourth embodiment of the present invention is an MOS-type solid-state imaging device, and not operated in the same manner with a CCD-type solid-state imaging device which reads out a signal by an electric charge transfer, thereby if these devices are compared assuming that no pixel addition is performed, an MOS-type solid-state imaging device is capable of reading out an electric charge signal faster than a CCD-type solid-state imaging device in general.

Therefore, in the CCD-type solid-state imaging device disclosed in the conventional technique (Japanese Patent Application Publication No. 2004-312140), it is necessary to add many pixels, or more specifically, nine pixels are added for high-speed implementation.

Meanwhile, the solid-state imaging device according to the fourth embodiment of the present invention realizes high-speed implementation by pixel addition as shown in FIG. 21 in the same manner with the conventional technique (Japanese Patent Application Publication No. 2004-312140), in which signal electric charge can be read out faster than the CCD-type solid-state imaging device disclosed in the conventional technique (Japanese Patent Application Publication No. 2004-312140) even in pixel addition of four pixels and three pixels which is smaller than nine-pixel addition, due to the MOS-type configuration.

Moreover, in the solid-state imaging device according to the fourth embodiment of the present invention, it is possible to obtain a resolution which is higher than that of the solid-state imaging device disclosed in the conventional technique (Japanese Patent Application Publication No. 2004-312140), due to pixel addition of four pixels and three pixels as shown in FIG. 21 which is smaller than nine-pixel addition.

Accordingly, in the solid-state imaging device according to the fourth embodiment of the present invention, improvement of resolution characteristics and implementation of high-speed readout can be recognized more than the conventional technique (Japanese Patent Application Publication No. 2004-312140).

Furthermore, the solid-state imaging device according to the fourth embodiment of the present invention is capable of obtaining superior image characteristics with less moires or fault resolutions than those of the solid-state imaging device disclosed in the conventional technique (Japanese Patent Application Publication No. 2001-36920), so that it is possible to prevent significant decrease of a vertical resolution with respect to a horizontal resolution caused by imbalance in pixel sampling density between the horizontal direction and the vertical direction, and prevent substantial sensitivity decrease because a signal of a pixel in a column which is not read out is not ejected.

In the solid-state imaging device according to the fourth embodiment of the present invention, it is possible to weight addition by differentiating the size of each capacity in the group of the signal storage capacities 52 in the configurations of FIG. 13 and FIG. 18.

In the solid-state imaging device according to the fourth embodiment of the present invention, an image obtained without performing pixel addition (hereinafter referred to as a first image) and an image obtained by performing pixel addition (hereinafter referred to as a second image) in the same solid-state imaging device can be both outputted as a still picture. This method is particularly effective for a single-lens digital still camera which does not photograph a motion picture in general. Moreover, the solid-state imaging device according to the fourth embodiment of the present invention is capable of outputting a motion picture in both the first image and the second image. The solid-state imaging device according to the fourth embodiment of the present invention is also capable of outputting the first image as a still picture and the second image as a motion picture, in the same manner with the conventional technique. Furthermore, the solid-state imaging device according to the fourth embodiment of the present invention is capable of outputting the first image as a motion picture and the second image as a still picture.

Although the solid-state imaging device according to the fourth embodiment of the present invention was exhibited by using the MOS-type solid-state imaging device as an example, it can be also realized by a solid-state imaging device which is not operated in the same manner with a CCD-type solid-state imaging device for reading out a signal by an electric charge transfer, examples including sensors of any types such as BASIS, CMOS sensor, SIT sensor, CMD, and AMI.

Although the solid-state imaging device according to the fourth embodiment of the present invention was explained in the case of employing a combination of four-pixel addition and three-pixel addition using FIG. 21, it can also be applied to the case of adding many pixels (ex. combination of nine-pixel addition and five-pixel addition) in a solid-state imaging device with an extremely large number of pixels (ex. 10 million pixels or larger) by arranging the position of gravity centers of respective colors in a relationship similar to that of FIG. 21.

### Fifth Embodiment

Explained below will be a solid-state imaging device and a driving method thereof according to a fifth embodiment of the present invention with reference to drawings.

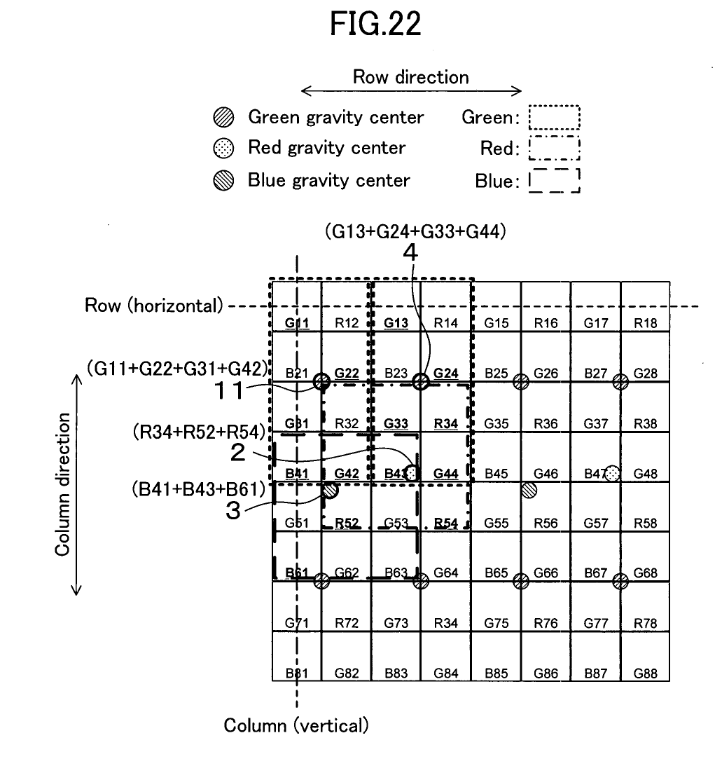

FIG. 22 is an image diagram showing a pixel addition pattern of the solid-state imaging device and the driving method thereof according to the fifth embodiment of the present invention. As shown in FIG. 22, a color filter array is a Bayer array for example, in which a filter pixel held by an R filter on both horizontal sides is made to be Gr, and a filter pixel held by a B filter on both horizontal sides is made to be Gb for convenience of explaining an operation, but Gr and Gb are the same color in practice.

In FIG. 22, G11, G22, G31, and G42 are formed into a G1 group in which the entire four pixels are added; B41, B43, B61, and B63 are formed into a B group in which B41, B43, and B61 are exclusively added; G13, G24, G33, and G44 are formed into a G2 group in which the entire four pixels are added; and R32, R34, R52 and R54 are formed into an R group in which R52, R34, and R54 are exclusively added, in order to perform pixel addition.

That is, in the solid-state imaging device according to the fifth embodiment of the present invention, pixel addition is carried out by using a combination of addition of four G pixels in the solid-state imaging device according to the second embodiment and addition of three R and B pixels.

Furthermore, the solid-state imaging device in this embodiment has an advantage of an easy image process, because gravity centers are positioned close to a square lattice shape, in spite of having slight sensitivity decrease due to three-pixel additions of R and B in comparison with four-pixel addition. There is another advantage of having a high horizontal resolution as characterized in the second embodiment.

Explained next will be a device configuration of the solid-state imaging device according to the fifth embodiment of the present invention. In the solid-state imaging device according to the fifth embodiment of the present invention, it is possible to employ any of first and second configurations to be described below.

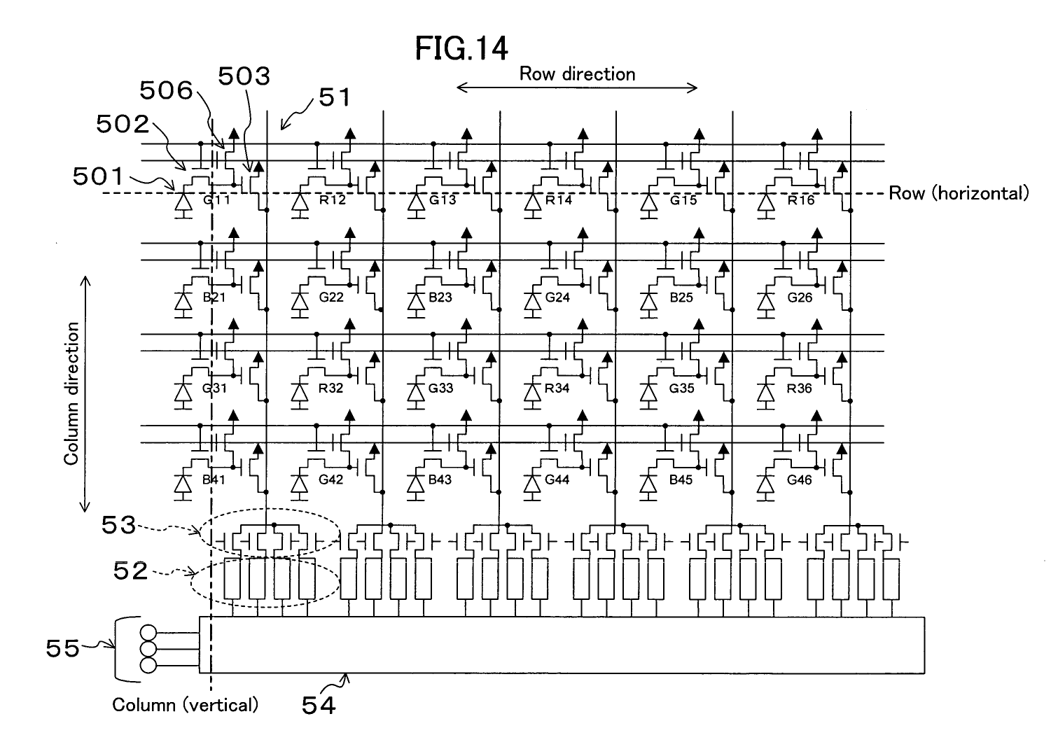

First, FIG. 14 is used to explain a first configuration of the solid-state imaging device according to the fifth embodiment of the present invention, in which pixel addition as shown in FIG. 22 is performed.

As shown in FIG. 14, the solid-state imaging device is an amplification-type solid-state imaging device, and light which was made incident to the photo diode 501 provided internally in a silicon substrate is photoelectrically converted and stored as electric charge. Electric charge is also transferred to a gate electrode of the amplifier transistor 503 after having been stored for a predetermined period of time by opening the transfer gate 502, and an amplified signal is outputted as a signal voltage to the vertical signal line 51 via a selection transistor.

Moreover, the group of the four signal storage capacities 52 is provided to correspond to the vertical signal line 51 which is provided to correspond to each column one by one. Furthermore, it is the group of the signal distribution switches 53 to distribute an output signal of the single vertical signal line 51 into the group of the four signal storage capacities 52. Addition of four pixels in the column direction and addition in the row direction are also performed by the horizontal multiplexer 54, so as to be distributed to the group of the horizontal output lines 55.

Although FIG. 14 does not show a selection transistor, a selection transistor may be provided in the first configuration.

Explanation will be made using FIG. 23 for the solid-state imaging device according to this embodiment in the case of providing no selection transistor. FIG. 23 is a circuit configuration diagram of a photoelectric conversion cell in an MOS-type image sensor according to the fifth embodiment of the present invention. In FIG. 23, 201 is a PD portion to perform photoelectric conversion; 202 is an FD portion to store photoelectrically converted electric charge; 203 is a transfer gate to transfer electric charge to the FD portion 202; 204 is a reset gate to sweep electric charge of the FD portion 202; 205 is a pixel amplifier to detect electric charge of the FD portion 202; 206 is a load transistor to form a source follower amplifier in cooperation with the pixel amplifier 205; 207 is a common power line to apply a common power voltage signal VDDCEL to the photoelectric conversion cell; 208 is a read pulse line to apply a read signal READ to the transfer gate 203; 209 is a reset pulse line to which a rest signal RESET for sweeping electric charge of the FD portion 202 is applied; 210 is an output signal line to transmit a pixel signal VD detected in the pixel amplifier 205; 211 is a load gate line to apply a load gate signal LGCEL to a gate of the load transistor 206; and 212 is a source common power line to commonly apply a source power voltage signal SCEL to the load transistor 206.

Moreover, in FIG. 14, the vertical signal line 51 is provided to correspond to each column one by one, and the group of the four signal storage capacities 52 is provided with respect to this single output line. Furthermore, it is the group of the signal distribution switches 53 to distribute an output signal of the single vertical signal line 51 into the group of the four signal storage capacities 52. Addition of four pixels in the column direction and addition in the row direction are also performed by the horizontal multiplexer 54, and an added signal is distributed to the group of the horizontal output lines 55. As it will be understood from this configuration, it is possible to store a signal of four pixels in the vertical direction while signals can be freely added in the horizontal direction by the horizontal multiplexer. Accordingly, pixel addition in this embodiment is made possible.

As explained above, the number of the horizontal storage capacities provided in the first configuration is doubled, which results in a simple device configuration because signals successively read out in each column can be stored in this storage capacities successively, so that there is an advantage of allowing for pixel addition as shown in FIG. 22 even in this simple configuration.

Addition of four G pixels here can be carried out by a method similar to addition of four G pixels in the first and second embodiments. Addition of three R and B pixels can also be realized in a method similar to addition of three R and B pixels in the third embodiment.

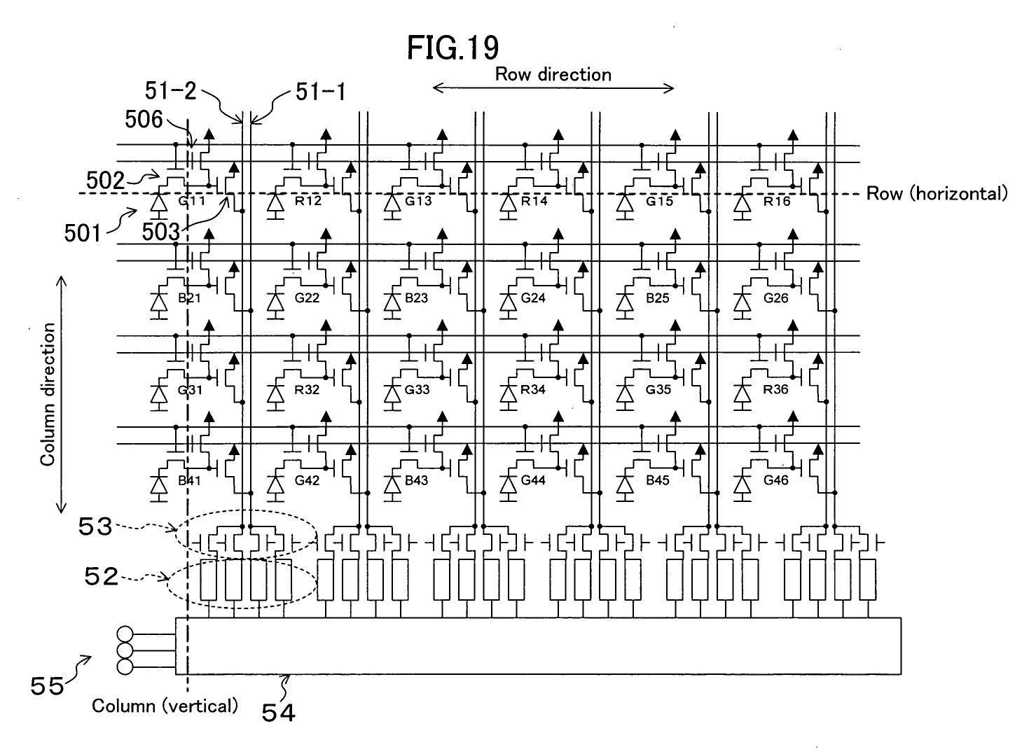

Next, FIG. 19 is used to explain a second configuration of the solid-state imaging device according to the fifth embodiment of the present invention, in which pixel addition as shown in FIG. 22 is performed.

As shown in FIG. 19, the solid-state imaging device is an amplification-type solid-state imaging device, and light which was made incident to the photo diode 501 provided internally in a silicon substrate is photoelectrically converted and stored as electric charge.

Electric charge is also transferred to a gate electrode of the amplifier transistor 503 after having been stored for a predetermined period of time by opening the transfer gate 502, and an amplified signal is outputted as a signal voltage to the vertical signal lines 51-1 and 51-2 via a selection transistor.

Moreover, two vertical signal lines, 51-1 and 51-2, are provided to correspond to an odd-number row and an even-number row. Furthermore, two horizontal storage capacities and two horizontal switches are provided for each of the vertical signal lines 51-1 and 51-2. It is the same as the first configuration that a total of the four horizontal storage capacities and a total of the four horizontal switches are provided for a single column.

Addition of four pixels in the column direction and addition in the row direction are also performed by the horizontal multiplexer 54, so as to be distributed to the group of the horizontal output lines 55.

A method to add signals is similar to that of the first configuration, and addition of four G pixels here can be carried out by a method similar to addition of four G pixels in the first and second embodiments. Addition of three R and B pixels can also be realized by a method similar to addition of three R and B pixels in the third embodiment.

As explained above, the second configuration allows readout of a signal through the two vertical signal lines by selecting and operating two adjacent columns simultaneously. Therefore, there is provided an advantage of allowing for improvement of a readout speed over the remaining configuration, because it is possible to deal with signals of two vertically adjacent pixels simultaneously.

As explained above by using the drawings of FIG. 22, FIG. 14, and FIG. 19, the solid-state imaging device according to the fifth embodiment of the present invention has following superior characteristics.

First, the solid-state imaging device according to the fifth embodiment of the present invention is an MOS-type solid-state imaging device, and not operated in the same manner with a CCD-type solid-state imaging device which reads out a signal by an electric charge transfer, thereby if these devices are compared assuming that no pixel addition is performed, an MOS-type solid-state imaging device is capable of reading out an electric charge signal faster than a CCD-type solid-state imaging device in general.

Therefore, in the CCD-type solid-state imaging device disclosed in the conventional technique (Japanese Patent Application Publication No. 2004-312140), it is necessary to add many pixels, or more specifically, nine pixels are added for high-speed implementation.

Meanwhile, in the solid-state imaging device according to the fifth embodiment of the present invention, high-speed implementation is realized by pixel addition as shown in FIG. 22 in the same manner as the conventional technique (Japanese Patent Application Publication No. 2004-312140), in which signal electric charge can be read out faster than the CCD-type solid-state imaging device disclosed in the conventional technique (Japanese Patent Application Publication No. 2004-312140) even in pixel addition of four pixels and partial three pixels which is smaller than nine-pixel addition, due to the MOS-type configuration.

Moreover, in the solid-state imaging device according to the fifth embodiment of the present invention, it is possible to obtain a resolution which is higher than that of the solid-state imaging device disclosed in the conventional technique (Japanese Patent Application Publication No. 2004-312140), due to pixel addition of a combination of four pixels and three pixels as shown in FIG. 22 which is smaller than nine-pixel addition.

Accordingly, in the solid-state imaging device according to the fifth embodiment of the present invention, improvement of resolution characteristics and increase of a readout speed can be recognized more than the conventional technique (Japanese Patent Application Publication No. 2004-312140).

Furthermore, the solid-state imaging device according to this embodiment is capable of obtaining superior image characteristics with less moires or fault resolutions than those of the solid-state imaging device disclosed in the conventional technique (Japanese Patent Application Publication No. 2001-36920), so that it is possible to prevent significant decrease of a vertical resolution with respect to a horizontal resolution caused by imbalance in pixel sampling density between the horizontal direction and the vertical direction, and prevent substantial sensitivity decrease because a signal of a pixel in a column which is not read out is not ejected.

In the solid-state imaging device according to the fifth embodiment of the present invention, it is possible to weight addition by differentiating the size of each capacity in the group of the signal storage capacities 52 in the configurations of FIG. 14 and FIG. 19.

In the solid-state imaging device according to the fifth embodiment of the present invention, an image obtained without performing pixel addition (hereinafter referred to as a first image) and an image obtained by performing pixel addition (hereinafter referred to as a second image) in the same solid-state imaging device can be both outputted as a still picture. This method is particularly effective for a single-lens digital still camera which does not photograph a motion picture in general.

Moreover, the solid-state imaging device according to this embodiment is capable of outputting both the first image and the second image as a motion picture. The solid-state imaging device according to this embodiment is also capable of outputting the first image as a still picture and the second image as a motion picture in the same manner as the conventional technique. Furthermore, the solid-state imaging device according to this embodiment is capable of outputting the first image as a motion picture and the second image as a still picture.

Although the solid-state imaging device according to the fifth embodiment of the present invention was exhibited by using the MOS-type solid-state imaging device as an example, it can be also realized by a solid-state imaging device which is not operated in the same manner as a CCD-type solid-state imaging device for reading out a signal by an electric charge transfer, examples including sensors of any types such as BASIS, CMOS sensor, SIT sensor, CMD, and AMI.

Although the solid-state imaging device according to the fifth embodiment of the present invention was explained in the case of employing a combination of four-pixel addition and three-pixel addition using FIG. 22, it can also be applied to the case of adding many pixels (ex. combination of nine-pixel addition and five-pixel addition) in a solid-state imaging device with an extremely large number of pixels (ex. 10 million pixels or larger) by arranging the position of gravity centers of respective colors in a relationship similar to that of FIG. 22.

### Sixth Embodiment

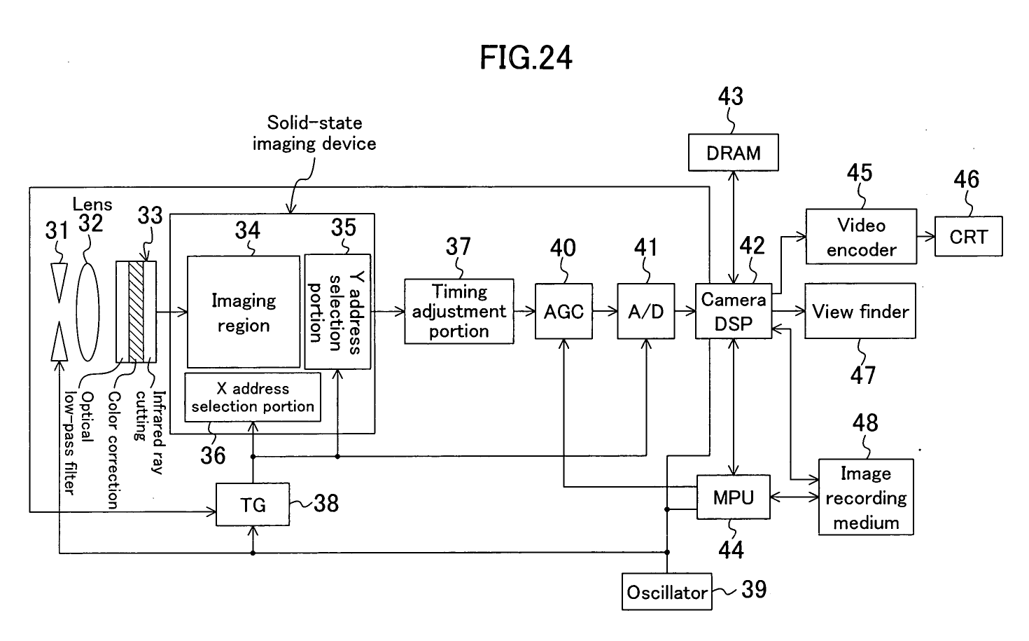

FIG. 24 is a device configuration diagram showing an imaging device according to a sixth embodiment of the present invention. Any of the solid-state imaging devices indicated in the first to fifth embodiments of the present invention can be used for a solid-state imaging device which is mounted in this embodiment.

The imaging device in this embodiment comprises a solid-state imaging device to perform photoelectric conversion; an aperture blade 31 to allow external light to pass therethrough; a lens 32 to converge external light; a group of filters 33 interposed between the lens 32 and the solid-state imaging device; a TG (timing generator) 38; a timing adjustment portion 37 to receive an output of the solid-state imaging device; an AGC (auto gain control) 40; an A/D converter 41; a camera DSP (digital signal processor) 42; a DRAM 43; an MPU 44; an oscillator 39; an image recording medium 48; a view finder 47; a video encoder 45; and a CRT 46. The solid-state imaging device can be any one of the solid-state imaging devices in the first to fifth embodiments, having an imaging region 34, an X address selection portion 36, and a Y address selection portion 35.

In the imaging device of this embodiment, light from a subject passes through the aperture blade 31, and an image is formed on a region 34 in which a light receiving portion having a color filter obtained from the lens 32 is formed (hereinafter referred to as a imaging region), so that photoelectric conversion is realized. In order to prevent generation of moires or the like here, the group of the filters 33 is provided by a combination of an optical low-pass filter for cutting a high pass of light, a color correction filter, and an infrared ray cutting filter or the like.

A light signal which was photoelectrically converted in the imaging region 34 is subjected to two-dimensional selection of a pixel position in the X address selection portion 36 and the Y address selection portion 35 by a signal from the TG (timing generator) 38, so as to be read out to the timing adjustment portion 37. This timing adjustment portion 37 adjusts timing of one to plural outputs from the imaging region 34. Then, the AGC 40 controls a voltage of a photoelectrical signal, so as to be converted to a digital signal in the A/D converter 41.

The camera DSP 42 processes an image of a motion picture or a still picture with respect to a converted digital signal. The MPU (micro processing portion) 44 sets parameters used for said image process in the camera DSP 42, and performs AE (automatic exposure) process and AF (automatic focus) processes. The DRAM 43 is used as a temporal storage region in processing an image, and the image recording medium 48 is used as a nonvolatile storage region.

The video encoder 45 and the CRT 46 are provided in order to display an image obtained after the image process. The view finder 47 is also provided in place of, for example, an LCD, and used for confirming a subject before storing in the image recording medium 48. These output devices are not limited to the CRT 46 and the view finder 47, and a printer or the like may be used.

When an addition readout mode and a full pixel readout mode are switched in the imaging region 34, the imaging device in this embodiment is configured to determine the mode by the MPU 44 and send a signal corresponding to each of the modes to the output devices including the CRT 46 and the view finder 47, the camera DSP 42, the image recording medium 48, the AGC 40, and the TG 38 or the like. The TG 38 here switches timing of an output signal depending on a motion picture and a still picture. Moreover, the camera DSP 42 is capable of having the same order of outputting signals in both of the modes, so that it is not necessary to change a process itself in each of the modes.

In an example of FIG. 24, the TG (timing generator) 38, the timing adjustment portion 37, the AGC 40, the A/D converter 41, the camera DSP 42, the MPU 44, the DRAM 43, and the video encoder 45 are disposed in the outside of the solid-state imaging device or in the outside of the same chip, but each of them may be disposed in the inside of the solid-state imaging device or within the same chip.

### COMPARATIVE EXAMPLE

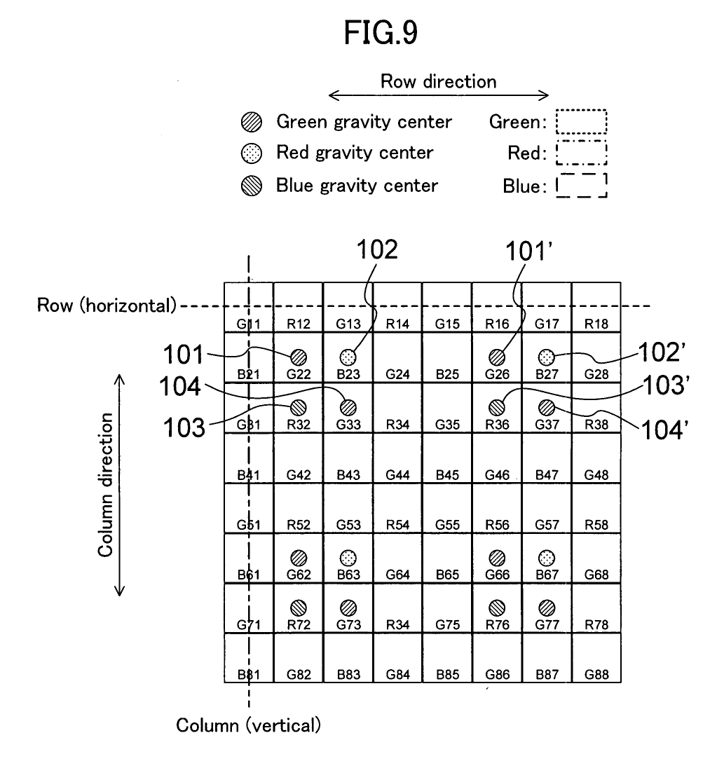

Explanation will be made for a comparative example according to the present invention using FIG. 9.

In an example shown in FIG. 9, vertically adjacent four pixels are added. If G11, G13, G31, and G33 are added, a gravity center thereof is made to be G1 gravity center 101. If R12, R14, R32, and R34 are added, a gravity center thereof is made to be an R gravity center 102. If B21, B23, B41, and B43 are added, a gravity center thereof is made to be a B gravity center 103. If G22, G24, G42, and G44 are added, a gravity center thereof is made to be a G2 gravity center 104. That is, if four pixels are added in the same manner as this comparative example, the gravity centers 101, 102, 103, and 104 are separated from respective adjacent gravity centers 101′, 102′, 103′, and 104′, and each of the gravity centers is localized, which causes problems such as having less resolution and generating moires. By comparison, the solid-state imaging device according to the present invention is capable of obtaining a sufficiently high resolution even if pixel addition is performed, and suppressing generation of moires or the like, because gravity centers obtained after adding pixels of respective colors are not unevenly distributed.

As explained above, the solid-state imaging device according to the present invention can be used for a single-lens digital still camera and a video camera or the like.

What is claimed is:

1. A solid-state imaging device having a plurality of pixels each including a light receiving portion arranged on a semiconductor substrate in a matrix form, pixels among the plurality of pixels to extract signals of green, red, and blue being assumed green pixels, red pixels, and blue pixels, respectively, so as to arrange a pair of the green pixels, the red pixel, and the blue pixel in a Bayer array, the solid-state imaging device having a drive mode to mutually add signals obtained from pixels of the same color, wherein:
horizontal two pixels and vertical four pixels of the green pixels are used as a basic unit of a green pixel addition area; and
horizontal three pixels and vertical three pixels of the blue pixels and the red pixels are used as a basic unit of a blue pixel addition area and a red pixel addition area, respectively,
whereby signals from the green pixels in the green pixel addition area, signals from the blue pixels in the blue pixel addition area, and signals from the red pixels in the red pixel addition area are mutually added.

2. The solid-state imaging device according to claim 1, wherein:
the green pixel addition area comprises a first green pixel addition area and a second green pixel addition area; and
the first green pixel addition area and the second green pixel addition area are arranged having a deviation of two pixels in the horizontal direction.

3. The solid-state imaging device according to claim 2, wherein the first green pixel addition area and the second green pixel addition area are arranged to overlap the blue pixel addition area and the red pixel addition area.

4. The solid-state imaging device according to claim 2, wherein:
the first green pixel addition area is arranged to overlap the blue pixel addition area and the red pixel addition area; and
the second green pixel addition area is arranged to overlap the red pixel addition area.

5. The solid-state imaging device according to claim 1, wherein:
the green pixel addition area comprises a first green pixel addition area and a second green pixel addition area; and
the first green pixel addition area and the second green pixel addition area are arranged in the same position in the horizontal direction.

6. The solid-state imaging device according to claim 5, wherein:
the first green pixel addition area is arranged to overlap the blue pixel addition area and the red pixel addition area; and
the second green pixel addition area is arranged to overlap the blue pixel addition area.

7. A solid-state imaging device having a plurality of pixels each including a light receiving portion arranged on a semiconductor substrate in a matrix form, pixels among the plurality of pixels to extract signals of green, red, and blue are assumed green pixels, red pixels, and blue pixels, respectively, so as to arrange a pair of the green pixels, the red pixel, and the blue pixel in a Bayer array, the solid-state imaging device having a drive mode to mutually add signals obtained from pixels of the same color, wherein:
horizontal two pixels and vertical four pixels of the green pixels are used as a basic unit of a green pixel addition area; and
horizontal three pixels and vertical three pixels of the blue pixels and the red pixels are used as a basic unit of a blue pixel addition area and a red pixel addition area, respectively,
whereby signals from the green pixels in the green pixel addition area, signals from one or some of the blue pixels in the blue pixel addition area, and signals from one or some of the red pixels in the red pixel addition area are mutually added.

8. The solid-state imaging device according to claim 7, wherein:
the green pixel addition area comprises a first green pixel addition area and a second green pixel addition area; and
the first green pixel addition area and the second green pixel addition area are arranged having a deviation of two pixels in the horizontal direction.

9. The solid-state imaging device according to claim 8, wherein the first green pixel addition area and the second green pixel addition area are arranged to overlap the blue pixel addition area and the red pixel addition area.

10. The solid-state imaging device according to claim 7, wherein:
the green pixel addition area comprises a first green pixel addition area and a second green pixel addition area; and
the first green pixel addition area and the second green pixel addition area are arranged in the same position in the horizontal direction.

11. The solid-state imaging device according to claim 10, wherein the first green pixel addition area and the second green pixel addition area are arranged to overlap the blue pixel addition area and the red pixel addition area.

12. The solid-state imaging device according to claim 1, comprising the light receiving portions, a transmission portion, an amplification portion, and a vertical signal line to transmit a signal from the amplification portion, wherein
the vertical signal line is provided with four signal storage portions in a rear stage thereof.

13. The solid-state imaging device according to claim 1, comprising the light receiving portions, a transmission portion, an amplification portion, and two vertical signal lines to transmit a signal from the amplification portion, wherein:
the vertical signal lines correspond to an odd-number row and an even-number row; and two signal storage portions are provided for each of the vertical signal lines.

14. The solid-state imaging device according to claim 13, wherein two selection portions are provided for each of the vertical signal lines in a rear stage of the signal storage portions.
